(19) United States
(12) Patent Application Publication
(10) Pub. No.: US 2003/0149122 A1
(43) Pub. Date: Aug. 7, 2003

(54) Complexing structure, device and method for treating liquid effluents

(76) Inventors: Christophe Bureau, Suresnes (FR); Franck Lederf, Angers (FR); Pascal Viel, Meudon (FR); Francis Descours, Monligny le Bretammeua (FR)

Correspondence Address: BURNS DOANE SWECKER & MATHIS L L P, POST OFFICE BOX 1404, ALEXANDRIA, VA, 22313-1404, US

(21) Appl. No.: 10/343,770

(22) PCT Filed: Aug. 29, 2001
(86) PCT No.: PCT/FR01/02692

(30) Foreign Application Priority Data
Aug. 30, 2000 (FR) 00 11074

(51) Int. Cl. C08J 5/20

(52) U.S. Cl. 521/25; 521/26

(57) ABSTRACT

The present invention relates to a complexing structure, to a method for treating liquid effluent using said complexing structure, and to a device for implementing the method of the invention. The structure comprises a film of a polymer or of an electrically neutral organic copolymer.

In addition, the present invention relates to a system and method for treating an effluent using said structure.

### TECHNICAL FIELD

The invention relates to a complexing structure, to a method for treating liquid effluent using said complexing structure, and to a device for implementing the method of the invention.

Surface treatment methods, the nuclear industry, the desalination of salt waters, or further the metallurgy of precious metals all produce effluent containing toxic and/or precious ions.

In the motor vehicle industry for example, zinc electro-coating produces effluent containing metals or their salts such as Zn, Co, Fe, Cr etc.. And as a general rule, this is also true for example in respect of electroplating and the chemistry of ordinary metals such as Cu, Fe, etc.. or noble metals such as Au, Pt, etc.., or further for the safety of nuclear installations.

Regarding the safety of installations in the nuclear sector, to overcome the scaling of walls by radioactive ions, the surfaces are given subsequent cleaning, with water in particular, which means that the problem under consideration is the treatment of a liquid effluent in an adequate unit.

Whether to limit losses of raw material, precious metals for example, or to conform with laws and regulations on liquid waste discharge levels, or even to capture toxic ions for safety purposes, most companies which produce liquid effluent are gradually compelled to conduct their own treatment of the waste waters they produce. Globally, these treatments consist of extracting the ions from the effluent and endeavouring to reduce the volume of this effluent until it is in solid form whenever this is possible.

It is to be noted that regional directives in France, as in the remainder of Europe, tend to lower authorized concentration levels of some toxic metal ions, such as copper and chromium, and tend to limit the maximum quantity of discharged waste water. per square metre of surface treated.

Moreover, the French Ministry of the Environment is currently planning to direct regulations towards “zero liquid discharge” by compelling companies only to discharge solid waste, the liquid part of the waste therefore being given closed circuit treatment.

### PRIOR ART

Water treatment units may comprise several types of ion-concentrating systems depending upon the flow rate of the effluent to be treated, the concentration of ions in the effluent, etc.. Whether this concentration is obtained by electrodialysis, reverse osmosis or even by evaporation, it systematically leads to the production of other ion-containing solutions. These are either more concentrated solutions, or less concentrated than the incoming effluent, but in general do not meet directives and current objectives of zero discharge.

Various additional systems may be used for ion treatment:

For example:

a “precipitation” unit: raw solutions arriving at the tank are treated in a strong base medium under heat and/or with sodium hydroxide so as to force the precipitation of hydroxides and/or carbonates of the metal salts present. The sludge obtained is then drained by means of filter-presses for example. The residual concentrations of the cations contained in the eluates depend upon the solubility products of the hydroxides and carbonates which precipitated in the sludge, and therefore vary according to the chemical nature of the ions. It can be estimated however that the sum of these concentrations is in the order of a few dozen to one hundred mg/l, that is to say well above currently authorized concentration levels which are close to 1 mg/l or a fraction of mg/l;

a filtering unit with which it is possible to reach low and very low concentrations; one of the systems most frequently used at present is ion exchange resins. These are polymer materials, most often packaged in cartridge form through which the liquid to be purified is passed, which are functionalised to capture the cations in the solution and to replace them by other non-toxic ions, in general alkaline ions such as sodium Na⁺. The solution obtained on leaving the ion exchange resins, after optional pH adjustment, generally conforms to the levels laid down by laws and regulations. Once saturated, the cartridges may be either be discarded and replaced by new cartridges, or they can be dismounted, regenerated using solutions such as acid solutions, sodium concentrated solutions etc.. to remove the captured ions. The regenerated cartridges may be re-used most often for up to ten cycles. If the cartridges are regenerated there are cases in which regeneration is performed locally with minimum equipment, and other cases where the cartridges are returned to the manufacturer for regeneration. Typical regeneration of a cation exchange resin, based on carboxylate or sulfonate groups grafted onto a polymer, comprises the following steps: (i) washing in water, (ii) acid washing, optionally cyclic, to remove the metal cations from the resin, (iii) rinsing with water, (iv) cleaning with sodium hydroxide to re-acidify the resin and replace the protons by sodium ions, (v) rinsing with water to re-stratify the resin and remove excess sodium hydroxide.

These two systems are not equivalent. Precipitation remains a “rough and ready method” to carry out the main part of the ion recovery work, but does not achieve sufficiently low concentrations to meet acceptable limits.

Ion exchange resins, on the other hand, can achieve low, even very low, concentrations but can only work efficiently with liquid waste that is already partly treated, by precipitation for example.

Therefore these systems alone are not always sufficiently effective.

It can be noted that in the particular case of radioactive effluent derived from the re-treatment of nuclear industry waste, liquid-liquid extraction is most often preferred to precipitation. Precipitation produces solid waste that is too voluminous, most often unable to be calcined, and leads to a certain number of ions other than those which are to be separated, which is a hindrance in an area in which separation is an objective at least as important as simple recovery.

Even if the systems based on ion exchange resins are among the most frequently used today in industry, they suffer from a certain number of weak points.

Their action, as the name indicates, consists of exchanging ions, and hence of replacing an unwanted cation by another which is less of an encumbrance. After treatment, the outgoing “de-ionized” solutions are highly concentrated in sodium, roughly in proportion to the concentrations of unwanted cations in the incoming solutions. Since sodium salts generally give products with very low solubility, these waters are nonetheless suitable for most boilers even though their saline level remains high.

In addition, intrinsically, the principle underlying the functioning of ion exchange resin cartridges is not suitable for continuous operation. With engineering this can be overcome by arranging several cartridges used in sequence until saturation, before being relayed by the next cartridge. The treatment capacity of cartridges remains limited however, in particular due to their size, the volume density of exchange groups etc.. The size of an installation is therefore closely connected, and is even homothetical, with the planned flow rate of the installation.

One of the advantages of liquid-liquid extraction is its simplicity of application, but this system remains subject to a certain number of major constraints.

The two liquid phases are, the most often, chosen for their non-miscibility. But this is not the only criterion: the ions sequestered by the molecular complexing agents must be more soluble in the extracting phase than in the extracted phase. This result is achieved at the expense of producing relatively complicated molecular complexing structures which at times are only adapted to a single type of ion.

In addition, since radioactive ions are most often cations, and the molecular complexing structures used for liquid-liquid extraction being the source of electrically neutral structures, an additional constraint has long been the co-extraction of the counter-ion ensuring global electric neutrality of the extracted structure, if only from a kinetics viewpoint, so that molecular engineering relative to the liquid-liquid extraction method concerns both the complexing structure and the production of specific counter-ions. However, the emergence of “all-in-one” solutions can be noted, in which molecular arms are directly fixed to the complexing structure which carry carboxylate functions acting as local counter-ion. These attempts however bring the method back to the concept of ion exchange, and make the production of raw materials permitting the extraction even more complex.

There appears to be a substantial need therefore for the development of new structures which do not have the above-mentioned disadvantages, and with which it is possible to treat effluent effectively so that ions can be extracted from it either because they are unwanted for example or because they are precious or noble.

### DISCLOSURE OF THE INVENTION

The purpose of the present invention is precisely to provide just such complexing structure which overcomes the above-mentioned drawbacks and can be used in all the above-mentioned applications.

The structure of the present invention is characterized in that it comprises a substrate on which a polymer film is grafted or a film of an electrically neutral organic copolymer able to complex ions.

According to the invention, the polymer or electrically neutral organic copolymer grafted onto the substrate may for example contain one more identical or different functional groups having complexing properties chosen from among amines, amides, ethers, carbonyls, phosphines, phosphine oxides, thio-ethers, disulfides, ureas, crown ethers, aza crowns, thio crowns, cryptands, sepulcrands, podands, porphyrines, calixarenes, pyridines, bipyridines, terpyridines, quinoleines, orthophenantroline compounds, naphtols, iso-naphtols, thioureas, siderophores, antibiotics, ethylene glycol, cyclodextrins and molecular structures that are substituted and/or functionalised from these functional groups, and/or one or more complexing cavities of redox lock type.

According to the invention, the polymer may for example be a polymer comprising a monomer chosen from among 4-vinyl pyridine, vinyl bipyridine, thiophene.

According to the invention, the polymer film or film of an organic copolymer preferably has thickness of approximately 10 μm or less.

For example, the polymer or organic copolymer film may be a copolymer of methyl methacrylate and of methyl methacrylate in which the methyl group of the ester has been replaced by a crown ether provided with a redox lock, or a copolymer of 4-vinyl pyridine and vinyl ferrocene or vinyl diferrocene.

According to the invention, the substrate may have different forms, which may for example be adapted to the intended use of the structure of the invention, that is to say to the type of effluent treatment method chosen according to the present invention. It may for example be chosen from among a plate, strip, tape, gauze, mesh, wire, bead, powder, chipping, tube etc..

The substrate may be formed in whole or in part from a conductor or semi-conductor material. If it is partly formed of a conductor or semi-conductor material this material may be on the surface.

The substrate may be made of a material chosen according to the intended use of the structure of the invention, that is to say for example according to the type of effluent treatment method chosen according to the present invention. It may for example be required to withstand drastic treatment conditions, acid or basic pH values for example and/or high temperatures. This material may for example be an organic material, or mineral such as glass or metal.

For example, the substrate may be in the form of a wire gauze or mesh, in 316L stainless steel for example.

The invention also relates to a method for treating liquid effluent to extract ions from the latter, said method comprising a step to contact the effluent to be treated with a structure according to the invention so that the ions to be extracted are complexed by said electrically neutral, organic polymer film.

According to the invention, in a first example of embodiment, the contacting step may be conducted by immersing the complexing structure in the effluent to be treated. In this case, the method of the invention may also comprise a step in which the complexing structure, on which the ions to be extracted from the effluent are complexed, is withdrawn from the treated effluent.

According to the invention, in a second example of embodiment, the contacting step may be conducted by passing the effluent to be treated over or through the complexing structure of the present invention. For example, the effluent may be placed in circulation in one or more cartridges in which are one or more complexing structures of the invention are arranged. For example also, the substrate may be an inner surface of a duct on which the complexing organic film of the invention is grafted. In this example, contacting may be made by causing the effluent to be treated to circulate inside the duct.

The method of the present invention may also comprise a step in which the ions complexed by the polymer are expelled, said expulsion possibly being performed by chemical route for example or by electro-assisted means. The chemical route may for example be performed by immersing the complexing structure in one or more decomplexing solutions, or by circulating one or more decomplexing solutions on the structure of the present invention.

According to one variant of the present invention, the method, in replacement of or in addition to the above-mentioned expelling step, may also comprise a substrate peeling step to remove the polymer film which complexed the ions, optionally followed by a depositing step of a new polymer film on the substrate.

According to the invention, the expelling of the complexed ions being made by chemical means, it may for example be conducted by immersing the organic polymer film in a solution containing a ligand having strong affinity for the ions complexed by this film.

For example, if the film is a film in poly-4-vinyl pyridine, the ions to be extracted from the effluent being copper and/or zinc ions, the latter may be expelled from the film by means of a method using hot water, a method using ammonia solutions or a combination of these two methods.

For example, the substrate being a conductor or semi-conductor substrate, the organic polymer grafted onto the substrate containing one or more complexing cavities provided with redox locks, the expelling of the complexed ions may for example be made by electro-assisted means by electrically polarising the conductor or semi-conductor substrate which carries the polymer film.

The present invention also relates to a device for the continuous treatment of an effluent to be treated, comprising:

a complexing structure according to the present invention,

a first container intended to hold the effluent to be treated containing the ions to be extracted,

a second container intended to hold a solution for expelling the ions complexed by the polymer of said structure, and

means for causing said structure to pass continuously, at controlled speed, and successively in the first container holding the effluent to be treated and then in the second container holding the solution to expel the ions complexed by the polymer of the complexing structure.

According to the invention, within the device, the substrate of the structure may for example be a tape whose ends join together, or a mesh. If the substrate is in mesh form, the structure may for example be placed in the buckets of a waterwheel system. In this case, the complexing structure is an assembly of mesh structures arranged in buckets, said buckets being driven by a waterwheel system.

According to the invention, the device may also comprise a command means with which it is possible to adjust the pass rate of the structure in the first container holding the effluent to be treated then in the second container, depending for example upon the flow rate of the effluent to be treated and/or the concentration of ions in the effluent to be treated and/or in relation to the speed of ion complexing and decomplexing by the organic film.

These means may for example be means controlling the advance rate of a tape with two joined ends, or means controlling the pass rate of a waterwheel driving the buckets.

According to another embodiment, the present invention also concerns a device for the continuous treatment of effluent to be treated, comprising:

a complexing structure according to the present invention,

a first container intended to hold the effluent to be treated containing the ions to be extracted, and

means to cause the effluent to be treated, at controlled speed and from the first container, to pass continuously on the surface of or through said complexing structure containing the effluent to be treated.

This system may also comprise a second container intended to hold a solution expelling the ions complexed by the structure of the present invention, and means to cause the complexed-ion expelling solution, at controlled speed and from said second container, to pass continuously on the surface of or through said complexing structure to regenerate this solution.

In this device, a complexing structure of the invention may for example be arranged in a single cartridge or in several identical or different cartridges. Different complexing structures according to the invention may also be used in different cartridges. The cartridges may remain fixed, and the effluent and expelling solution may pass over the surface of or through the structure.

### DETAILED DESCRIPTION OF THE PRESENT INVENTION

The present invention particularly relates to a complexing structure and to a method using said structure. It concerns surface complexing. The structure comprises a substrate and an organic coating deposited in film form, preferably thin film. The coating is a polymer which is able to complex ions, cations in particular; unlike ion exchange resins, complexing is conducted on a much reduced volume of matter, equivalent to the sum of the surface area treated by the thickness of deposited polymer film. The thicknesses under consideration are in general ten micrometres or less. In order to increase the quantity of polymer per surface unit, the polymer may for example be deposited on divided substrate surfaces: gauze, fine mesh, beads, chippings, powders, etc..

By using stainless steel mesh for example, and by varying the number of wires per surface unit, 2.54 cm (1 inch) for example, an object is obtained able to comprise an actual surface area of a few dozen cm² per cm² of mesh.

A certain number of advantages in connection with the use of a thin film of the invention are set forth below.

The complexing material is made integral with a carrier, the substrate, and can therefore be easily handled mechanically for example by peeling, immersing, extracting, rinsing, etc.. This avoids problems of differential solubility inherent in phase transfer for liquid-liquid extraction, or filtering-related problems with ion exchange resins. The progress achieved in terms of handling the complexing substance is similar to that achieved a few decades ago when homogeneous catalysis or phase transfer catalysis gave way to. heterogeneous catalysis. In view of the above, by eliminating the problem of extraction and co-extraction of the counter-ion, as in liquid-liquid extraction, it has become possible to work with electrically neutral extracting structures, and therefore to avoid returning to a tactic of “ion exchange” type. This will be described in the following paragraphs.

When using a tape substrate according to the invention, the volume of the complexing polymer on the tape may be low on account of the thin thickness of the film, and polymer impregnation both by the solution to be treated, or solution to be purified, and by the film regeneration solution during the ion expelling step will be rapid. In other words, the complexing and the decomplexing times are short, which makes it possible to set up a tape advance system using tape coated with complexing polymer, in which a virgin complexing zone is brought opposite the solution to be treated, and in which the tape advance speed is an adjustable parameter to meet variable flow rate requirements and/or varying concentrations of polluting ions, in which the speed of movement is for example a slave function of a measured flow rate or concentration. In this respect, the system of the invention based on the use of thin complexing films grafted onto substrate surfaces, is able to respond to a comprehensive range of flow rates without having to be modified, unlike current systems in which the volume of resin is homothetical with flow rate.

With this system it is possible, having regard to a mesh substrate for example, to manufacture a device able to operate continuously: for example by means of a tape made from these meshes coated with complexing polymer. This tape, whose ends meet, may be immersed at a given site in the solution to be purified and, at a further site, in the decomplexing regeneration solution before it returns to the solution to be purified.

Whereas for ion exchange resins, a minimum volume of regeneration solution needs to be used corresponding to the volume needed for wetting the entirety of the resin, the volume required for expelling the ions from the tape and for tape regeneration according to the invention is practically nil; only a small volume is sufficient in which the tape is immersed centimetre by centimetre. The immersion time may be dictated solely by the speed of decomplexing and rate of movement of the tape. With the method using the present invention, it is possible to achieve considerable gains in the ratio between the volume of effluent treated and the volume of recovery solutions relative to the methods which use ion exchange resins.

The present invention also applies to the capture of polluting organic molecules by the grafted films. This is another embodiment of the invention since solely the chemical structure of the monomer used to produce the polymer film is modified.

The structure of the present invention provides for ion complexing and expelling and not for ion exchange. It concerns complexing using electrically neutral structures.

The polymer films used according to the invention are obtained from monomers or electrically neutral co-monomers, able to capture ions by forming dative bonds.

The monomers used to produce the complexing films of the present invention are determined in particular in relation to the desired functionalities of the polymer film grafted on the substrate, in its end state. These monomers preferably comprise at least two of the following functionalities: (i) ability to polymerise or co-polymerise; (ii) capacity to convey a functional group or a complexing molecular structure; (iii) capacity to convey a functional group or an expelling molecular structure.

The monomers under consideration may schematically be made up of the three following potential functionalities or separate “modules” as follows:

One module ensuring the polymerisation reaction: this module is generally formed of an unsaturated functional group, a double bond for example, a set of conjugate double bonds or an unsaturated cycle, and an electro-attractive group or electro-donor group enabling electronic activation of the unsaturated polymerising group. For cathode electro-polymerisation, these may be fully aprotic vinyl monomers in which the vinyl carbon is electrophilic, for example an insulating vinyl polymer, 4-vinyl pyridine for example such as described by C. Lebrun, G. Deniau, P. Viel, G. Lécayon, in Surface Coatings Technology, 100-101, 474 (1998), 2-vinyl pyridine, acrylonitrile such as described by G. Deniau, G. Lécayon, P. Viel, G. Hennico, J. Delhalle, Langmuir, 8, 267 (1992), ethyl acrylate, methyl methacrylate such as described in French patent n° 98 14351 of Nov. 16, 1998, etc..; for anode electropolymerisation, reverse demand vinyl monomers in which the vinyl carbon is nucleophilic (insulating vinyl polymers: N-vinyl pyrrolidone such as described by E. Léonard-Stibbe, G. Lécayon, G. Deniau, P. Viel, M. Defranceschi, G. Legeay, J. Delhalle, in Journal of Polymer Science A, 32, 1551 (1994), or conjugate monomers such as conductor polymers: thiophene, aniline, pyrrole, etc.. For polymerisation by chemical route, these may be any type of polymer whether obtained by cationic, anionic or radical means, polyethylene glycol for example, such as described by K. Gogova, I. Zuskova, E. Tesarova, B. Gas,in Journal of Chromatography A., 838, 101 (1999). It is to be noted that this polymerisation module may itself have complexing properties (4-vinyl pyridine such as described by C. Lebrun, G. Deniau, P. Viel, G. Lécayon, in Surface Coatings Technology, 100-101, 474 (1998), 2-vinyl pyridine, ethylene-imine such as described by A. I. Kokorin, A. A Pridantsev, in Zhurnal Fizicheskoi Khimii, 71, 2171 (1997) and by E. A Osipova, V. E. Sladkov, A. I. Kamenev, V. M. Shkinev, K. E. Geckeler, in Analytica Chemica Acta, 404, 231 (2000), N-vinyl pyrrolidone such as described by E. Léonard-Stibbe, G. Lécayon, G. Deniau, P. Viel, M. Defranceschi, G. Legeay, J. Delhalle, in Journal of Polymer Science A, 32, 1551 (1994), or it may not have these properties such as acrylonitrile, methacrylonitrile, methyl which may be intended to be functionalised subsequently by a complexing structure, or to be the co-monomer of a structure with another monomer, whether functionalised or not, itself having complexing functions.

A functional group having complexing properties in respect of the cations of interest for example. This group may concern any neutral molecular structure permitting cation complexing, that is to say structures having free doublets, therefore containing non-quaternised nitrogen atoms, sulphur atoms or oxygen atoms. Amines, amides for example come under this list and crown ethers such as those described by (a) E. Simunicova, D. Kaniansky, K. Korsikova, Journal of Chromatography A, 665, 203 (1994), (b) Y. C. Shi, J. S. Fritz, Ibid., 671, 429 (1994), aza crowns, thio crowns, cryptands, sepulcrands, podands, porphyrines, such as those described by A. V. Udal'tsov, A. A. Churin, K. N. Timofeev, Y. V. Kovalev, in Biokhimiya (Moscow), 64, 949 (1999), calixarenes, pyridines such as those described by C. Lebrun, G. Deniau, P. Viel, G. Lécayon, in Surface Coatings Technology, 100-101, 474 (1998); bipyridines, quinoleines, compounds of ortho-phenanthroline, naphtols, iso-naphtols, thioureas such as those described by A. V. Udal'tsov, A. A. Churin, K. N. Timofeev, Y. V. Kovalev, in Biokhimiya,(Moscow), 64, 949 (1999), natural siderophores: enterobactine, desferrichrome, desferrioxammine B, etc.. or synthetic siderophores: N,N-bis (2-hydroxyethyl) glycine, 2,3-dihydroxy benzoylglycine, benzhydroxamic acid etc.., antibiotics, ethylene glycol, cyclodextrins such as those described by J. F. Bergamini, M Belabbas, M. Jouini, S. Aeiyach, J. C. Lacroix, K. I. Chane-Ching, P. C. Lacase, in Journal of Electroanalytical Chemistry, 482, 156 (2000), and molecular structures substituted and/or functionalised from these structures.

A functional group ensuring expulsion of the complexed ion, so as to regenerate the capture site. Such “molecular locks” are described for example by (a) P. L. Boulas, M. Gomez-Kaifer, L. Echegoyen, in Angewandte Chemie, International Edition in English, 37, 216 (1998); (b) A. E. Kaifer, S. Mendoza, in Comprehensive Supra-Molecular Chemistry, Vol. 1, Eds. J. L. Atwood, J. E. Davies, D. D. MacNicol, F. Vögtle, Pergamon, Oxford (1996), pp. 701-732; (c) P. D. Beer, P. A. Gale, G. Z. Chen, in Coordination Chemistry Review, 185-186, 3 (1999); (d) H. Plenio, D. Burth, in Organometallics, 15, 1151 (1996); (e) P. D. Beer, K. Y. Wild, Polyhedron, 15(18), 775 (1996). These compounds, also called “redox locks” are used to produce self-regenereating complexing cavities, that can be electrochemically piloted, and may be used as basic modules for ultra-selective and ultra-sensitive electrochemical sensors of ions in solution. The inventors recommend their use here not for analytical purposes but for the purpose of producing self-regenerating complexing and expelling sites for the treatment of liquid effluent.

It is to be noted that some non-functionalised neutral monomers, that is to say only comprising the polymerisation “module”, may have intrinsic complexing properties. This is the case for example with 4-vinyl pyridine such as described by C. Lebrun, G. Deniau, P. Viel, G. Lécayon, in Surface Coatings Technology, 100-101, 474 (1998), with 2-vinyl pyridine, vinyl bipyridine, thiophene, etc.. It is therefore not essential to provide them with an additional complexing functionality.

Globally, the polymers likely to be used in the present invention are therefore those obtained either from the above non-functionalised monomers, or from functionalised monomers, or from a mixture i.e. co-polymer of monomers functionalised with non-functionlised monomers. The polymer or co-polymer obtained may itself be subsequently functionalised by chemical means for example, to unprotect functions which had to be protected for example at the time of polymerisation; silylation of OHs for anionic electropolymerisation, etc..

Functionalising may be made on the monomers and/or co-monomers before synthesis of the monomer and/or co-monomer, or by chemical reaction on the polymer or already formed copolymer.

Contrary to the case with ion exchange resins, the counter groups of these neutral polymers or copolymers exist in the free state. With ion exchange resins the groups which capture the cations are electrically charged: these are most often carboxylic groups (COO₋) or sulfonate groups (SO₋) for cations, and ammonium groups (—NH₃⁺) for anions, which cannot exist in the free state, and are therefore always accompanied by a counter-ion: either the regeneration ions, sodium for example for cation resins, or undesirable ions present in the solution.

In the case of the present invention, the polymer assembly must be electrically neutral. The undesirable ions are trapped by the complexing polymer and their counter-ion is carried away with them, but they are not replaced by another ion. It is therefore a matter of ion capture and not ion exchange; the ions captured by the complexing polymer may then be expelled from the polymer, by the various means described below, in a much reduced volume in which the undesirable ions are concentrated.

Expulsion may be made by chemical means or by electrically assisted means.

Several methods may therefore be considered to expel the ions from the complexing polymer, once they have been captured in the polymer.

By chemical means: the polymer film is immersed in a solution containing a ligand having a very high affinity for the ions complexed in the film. With a poly-4-vinyl pyridine film for example, the copper or zinc cations may be easily expelled from the film, for example by treatment with hot water, ammonia solutions (NH₃) or a combination of both methods. As explained in the applied examples below, the copper ions become less easily expellable the more the recovery solution becomes concentrated in copper ions. A concentration threshold exists, beyond which the ions can no longer be expelled from the polymer film. It is evidently of interest that this concentration should be as high as possible so as to increase the ratio between the volume of treated effluent and the volume of the corresponding discharge solution. If this chemical method uses a similar discharge solution to the above-mentioned techniques, the volumes it requires are intrinsically far less than those for an ion exchange resin.

For example, in the method of the present invention which uses a tape coated with a layer of complexing polymer, whereas for the ion exchange resin a minimum volume of regenerating solution is required corresponding to the volume needed to wet the entire resin, the irreducible volume needed to expel the ions from the tape and to regenerate the tape is practically nil: in fact a small volume is sufficient in which the tape is immersed centimetre by centimetre. Immersion time is only dictated by the speed of decomplexing and the tape advance rate.

By electrochemical route: a copolymer film may for example be previously grafted in which the structure monomer may be methyl methacrylate (MMA), and the functionalised monomer is a MMA in which the methyl group of the ester has been replaced by a crown ether provided with its redox lock. The principle is simple: the lock is an oxidizable or reducible group, therefore having at least one redox potential (E°). It is joined by a covalent bond or bonds to the complexing cavity, a crown ether for example, so that the lock/cavity centre distance is a few Angströms.

In the example of an oxidizable lock, which is neural in the reduced state, positively charged in the oxidized state: in the reduced state (E<E°), the complexing cavity is “open” and is able to capture a cation. Once complexing is completed, the redox lock (E>E°) is oxidized: the lock is positively charged and therefore compels expulsion of the cation located in the cavity by oxidized-lock/cation electrostatic repulsion. For as long as the lock is positively charged, that is to say is in its oxidized form, the complexing cavity is “closed” and cannot capture any new ion. Once the cation is expelled, it is possible to return to the reduced form of the lock (E<E°) to make it electrically neutral once again and allow the cavity to complex a further time. Under the present invention, advantage can be taken from the fact that the complexing polymer is a thin film grafted onto a surface: if a metal surface is used, it is easy to pilot the oxidation state of the locks, by electrically polarising the metal surface carrying the film of complexing polymer. It then suffices to cause opening of the cavities (E<E°) when the tape passes through the complexing bath, and their closing with expelling into the discharge bath (E>E°). With this type of method, expulsion is achieved without the use of any chemical reagent whatsoever.

The same type of result can be obtained by producing a copolymer in which the complexing functions and the expelling functions are separate, that is to say are carried by different co-monomer molecules. It is for example possible to produce a film by co-polymerising 4-vinyl pyridine, for the complexing function, with vinyl ferrocene or vinyl diferrocene for the expelling function. Several pyridine cycles being necessary for complexing a cation, the relative concentration of the two co-monomers must be adjusted to equilibrate the ratio between the complexing functions and the expelling functions. It is possible to associate all the monomers carrying a complexing function previously cited with any redox group existing in charged “n+” form in the oxidized state and in neutral form in the reduced state, cations, or in neutral form in the oxidized state and “n−” charged in the reduced state, anions. If vinyl 18-crown-6 is used as complexing monomer for example, and vinyl ferrocene as expelling monomer, it may be necessary to use a structure terco-monomer, such as vinyl pyridine or acrylonitrile for example, to promote the kinetics of polymerisation and film construction. Vinyl 18-crown-6 and vinyl ferrocene having voluminous counter groups, the kinetics of polymerisation may be slow if they are used alone. Some of these aspects of synthesis by co-polymerisation are further discussed in the applied examples given below.

The same type of reasoning applies to the use of supra-molecular cavities enabling capture of anions, as described by (a) P. D. Beer, S. W. Dent, N. C. Fletcher, T. J. Wear, Polyhedron, 15(18), 2983 (1996); (b) P. D. Beer, A. R. Graydon, A. O. M. Johnson, D. K. Smith, in Inorganic Chemistry, 36, 2112 (1997); (c) J. E. Kingston, L. Ashford, P. D. Beer, M. G. B. Draw, in Journal of the Chemical Society, Dalton Transactions, 251 (1999); (d) P. D. Beer, Accounts on Chemical Research, 31, 71, (1998); (e) V. B. Arion, P. D. Beer, M. G. B. Drew, P. Hopkins, Polyhedron, 18, 451 (1999). The literature mentions their performance for analytical purposes, for the detection of anions in very small quantities. Under the present invention, the inventors recommend their use for sequestering and expelling undesirable anions in selective manner such as chromates, nitrates, etc.., by making them integral with the polymer film chemically grafted onto a surface.

The same reasoning can be applied to the use of supra-molecular cavities enabling the capture of more complex organic molecules than mineral ions alone. It is therefore possible to produce grafted films whose basic monomer, or one of its co-monomers, is formed of a MMA functionalised by a cyclodextrin molecule such as described by J. F. Bergamini, M. Belabbas, M. Jouini, S. Aeiyach, J. C. Lacroix, K. I. Chane-Ching, P. C. Lacaze, Journal of Electroanalytical Chemistry, 482, 156 (2000), and molecular structures substituted and/or functionalised from these structures for example.

Other characteristics and advantages of the present invention will become apparent on reading the following examples and appended figures.

### SHORT DESCRIPTION OF THE FIGURES

FIG. 1 is a recording obtained with an oscilloscope during synthesis of a P4VP film by electropolymerisation on the surface of a metallized glass strip,

FIG. 2A shows two global spectra before (top figure a), and after (bottom figure b) the complexing of copper in a copper solution using P4VP film,

FIG. 2B shows an enlargement of the two global spectra in FIG. 2A respectively, at the region around 1600cm⁻¹, before (top figure a) and after (bottom figure b) the complexing of copper in a copper solution by P4VP film.

FIG. 3A shows an IRRAS spectrum giving the results recorded in relation to time at the infrared bands (IR) of pyridine and its complex with copper for a P4VP film immersed in 15 mg/l copper solution,

FIG. 3B shows the proportion of complexed copper estimated from the surface areas of IRRAS bands in relation to immersion time of P4VP film,

FIG. 4 shows three IRRAS spectra illustrating treatment of the film of the present invention with hot water, at the top at 25° C., in the middle at 70° C. and at the bottom at 1000° C.,

FIG. 5 shows an IRRAS spectrum of the pyridinium form after acid washing then rinsing in water in an organic polymer film of the invention,

FIG. 6 shows three IRRAS spectra which illustrate: (1) an initial, non-complexed, P4VP film, (2) a complexed P4VP film, and (3) a film decomplexed by treatment with NH₃/hot water,

FIG. 7 shows three XPS spectra which illustrate: (1) an initial, non-complexed, P4VP film, (2) a complexed P4VP film, and (3) a film decomplexed by NH₃/hot water treatment,

FIG. 8 shows three IRRAS spectra of P4VP film illustrating: (1) an initial, non-complexed, P4VP film, (2) a film after 5 cycles of complexing/expelling, and (3) a film after 150 cycles of complexing/expelling, the continuous line representing the “decomplexed” film, and the dotted line representing the “complexed” film,

FIG. 9 shows three IRRAS spectra of P4VP film illustrating: (1) an initial, non-complexed, P4VP film, (2) a film after 1 cycle of complexing/expelling, and (3) a film after 4 cycles of complexing/expelling, the continuous line representing the “decomplexed” film, and the dotted line representing the “complexed” film,

FIG. 10 is a diagram of a cell designed from two Teflon blocks with a membrane separator for surfaces of average size, FIG. 10A giving a transparent perspective view of said cell, FIG. 10B showing a side view of one of the two blocks after separation of the second block, FIG. 10C giving a section view through a plane that is perpendicular to the view in FIG. 10B,

FIG. 11 shows cross-linking of the polymer chains isolated by a molecule of divinyl benzene,

FIG. 12 is a profile view of the thickness of a film obtained in the presence of 5% DVB, measured perpendicular to a scratch made in the film by means of a stylus when exerting a stylus pressure of 5 mg,

FIG. 13 gives four IRRAS spectra showing the influence of DVB content on film thickness,

FIG. 14 shows the thickness profile of a film obtained in the presence of preformed oligomers, measured perpendicular to a scratch made in the film by means of a stylus using a stylus pressure of 5 mg,

FIG. 15 shows three spectra obtained by IR microscopy on a STAINLESS STEEL mesh,

FIG. 16A is an image obtained with a scanning electron microscope, magnification×200, of a non-coated stainless steel mesh,

FIG. 16B is an image obtained with a scanning electron microscope, magnification×200, of a stainless steel mesh coated with an organic P4VP polymer film according to the present invention,

FIG. 17 is a diagram of continuous effluent treatment device according to the invention comprising a waterwheel system,

FIG. 18 is a diagrammatic perspective view of a bucket in the waterwheel system illustrated in FIG. 17 on its driving rail,

FIG. 19 is a schematic section view of one of the buckets in the waterwheel system shown in FIG. 17,

FIG. 20 is a graph showing changes in copper concentrations of an effluent in relation to the number of passes of the effluent in a bucket containing a complexing structure of the invention,

FIG. 21 shows the molecular structure of vinyl ferrocene (left) and 4-vinyl benzo 18-crown-6 used in one of the embodiments of the present invention,

FIG. 22 is a graphic representation of an IRRAS spectrum of a poly-(vinyl-ferrocene) film obtained with grafting by electropolymerisation under cathode polarisation according to the present invention,

FIG. 23 is a graphic representation of the I (mA) voltammetric response in relation to E (mV) of a 20 nm film of poly-(vinyl ferrocene) grafted on platinum by electropolymerisation under cathode polarisation according to the present invention,

FIG. 24 is a graphic representation of an IRRAS spectrum of a film of vinyl-ferrocene and 4-vinyl benzo 18-crown copolymer according to the present invention, and

FIG. 25 is a graphic representation of the I (mA) voltammetric response in relation to E (mV) of a 40 nm film of poly-co-(vinyl ferrocene-4-vinyl benzo 18-crown-6) grafted on platinum by electro-polymerisation under cathode polarisation according to the present invention.

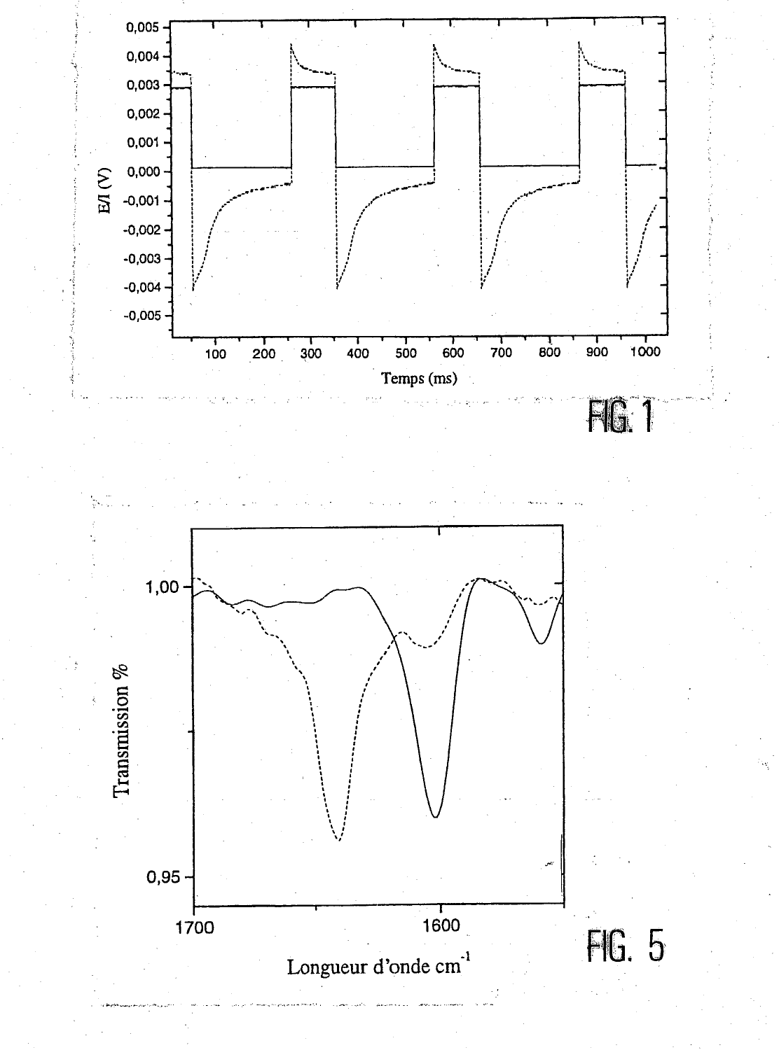

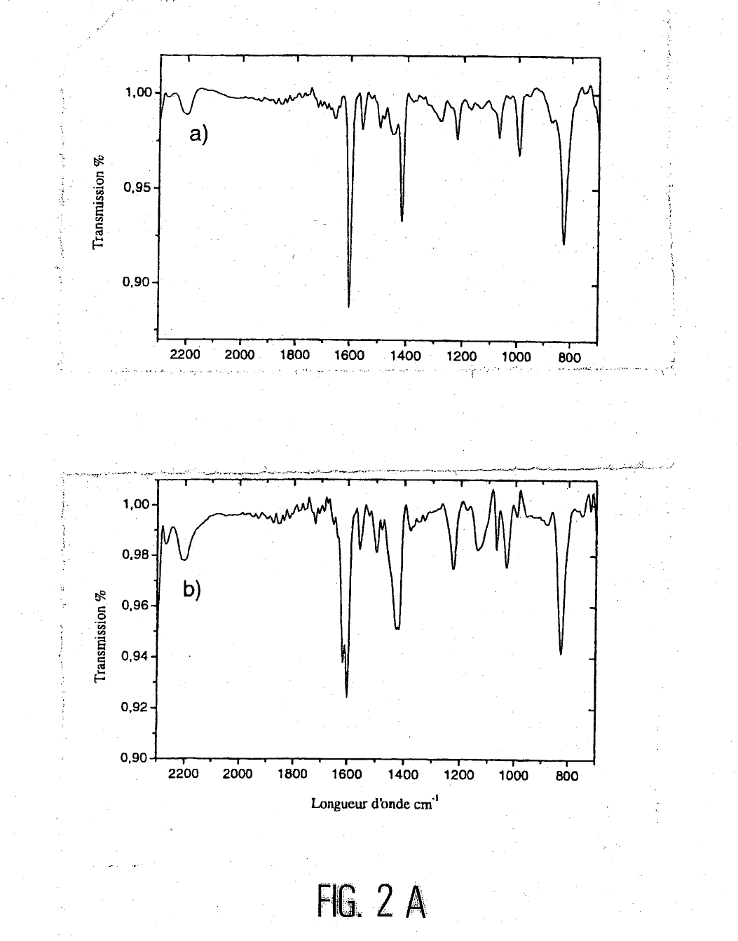

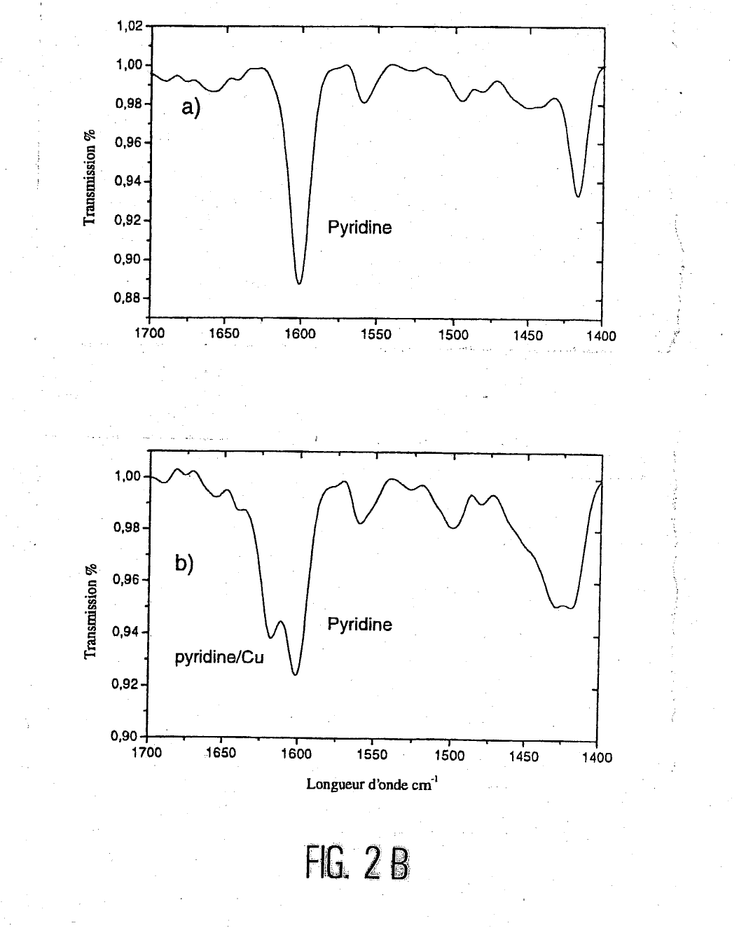

### EXAMPLES OF APPLICATION

1. The Substrates

Metal mesh: to meet the requirements of adsorption necessitating a substantial exchange surface, the substrates chosen here are woven metal meshes. These materials are generally used in the filtering sector.

The diameter of the wires and the type of mesh make it possible to obtain nominal opening sizes ranging from a few micrometres to a few dozen micrometres. Under these conditions, very fine dividing of the liquid passing through the filter is achieved. In a situation in which the polymer is not electroactive, i.e. a conductor polymer, there is no force to direct the copper ions towards the adsorbing surface, and consequently the division of the liquid becomes essential in order to promote the formation of the cupro-pyridine complex. Also, since the aim is to capture species of atomic size such as copper salts, it would appear obvious that a high number of passes of the liquid through the mesh is needed to increase the chances of the two entities meeting. This aspect will be discussed further in the description of the purification device of the invention.

Nominal opening: to obtain the greatest possible developed surface, and the finest division of the liquid, the inventors have, from among the different mesh characteristics available on the market, chosen those manufactured with the finest wires and which, with greatest number of wires per centimetre of mesh, offer the smallest nominal opening. However, consideration had to be given to phenomena of load losses through the mesh, related to friction forces and mesh fouling by calcareous particles for example.

The meshes chosen have a nominal opening of 50 micrometres and an actual geometric surface of 8 cm² per apparent cm² of mesh, 220.5 wires/cm (560 wires/inch) with a diameter of 100 microns, weft: 15.7 wires/cm (40 wires/inch) and diameter of 180 microns (see table I below).

Type of wire metal: to limit corrosion problems related either to the type of medium to be purified or to ion expelling methods, the mesh wires chosen were in 316L stainless steel. It was found during preliminary testing that nickel surfaces showed signs of corrosive attack in chloride media such as CuCl₂.

TABLE 1
Characteristics of woven metal meshes
(SPORL, Fenoyl Filtration)

| Warp | Weft | Number | | Number | Actual | | Nominal |
|---|---|---|---|---|---|---|---|
| diam. | diam. | Warps/cm | | wefts/cm | surface area | | opening |
| (mm) | (mm) | (inch) | | (inch) | (cm²/cm²) | | (μm) |
| 0.007 | 0.004 | 65 | (165) | 1400 | 551 | (8.48) | 10 |
| 0.007 | 0.005 | 65 | (165) | 800 | 315 | (6.47) | 15 |
| 0.0125 | 0.0071 | 31.5 | (80) | 400 | 157.5 | (4.82) | 35 |
| 0.018 | 0.014 | 15.7 | (40) | 200 | 78.7 | (4.42) | 55 |
| 0.036 | 0.026 | 9.5 | (24) | 110 | 43.3 | (4.67) | 80 |
| 0.006 | 0.0045 | 78.7 | (200) | 600 | 236 | (4.89) | 20 |
| 0.018 | 0.01 | 15.7 | (40) | 560 | 220.5 | (7.93) | 50 |
| 0.025 | 0.02 | 7.9 | (20) | 230 | 90.6 | (6.90) | 100 |
| 0.01 | 0.0076 | 31.5 | (80) | 700 | 275.6 | (7.68) | 25 |
| 0.025 | 0.015 | 11.8 | (30) | 360 | 141.7 | (7.72) | 80 |
| 0.023 | 0.018 | 11.8 | (30) | 150 | 59.1 | (4.25) | 65 |

2. Synthesis of a Complexing Structure of the Invention

Electropolymerisation: the grafting and film growth steps for the P4PV films are conducted by electropolymerisation. With this method it is possible to produce chemically stable, homogeneous films of controlled thickness. The synthesis medium used is made up of a solvent, acetonitrile, a monomer, as co-solvent, since its concentration is 50%, and a carrier salt, tetraethylammonium perchlorate (TEAP). The high proportion of the monomer is justified by the desire to promote a secondary electrode reaction which leads to the formation of the grafted film. The electropolymerisation method corresponding to an electro-primed polymerisation reaction consumes very little electricity since the reduction of one monomer molecule is sufficient to initiate a compete polymer chain. Consequently, this method relies little upon field lines present within the cell and is perfectly suitable for the coating of complex shaped surfaces, such as mesh structures in the case in hand.

Synthesis is conducted in pulsed potentiostatic mode. This mode provides better control over chain growth conditions by limiting the quantities of injected current, primer reaction, to privilege growth reactions. Also, the resting times can be used to re-supply the interface with monomer by diffusion.

The operating mode for synthesis is described for example by C. Lebrun, G. Deniau, P. Viel, G. Lécayon in Surface Coatings Technology, 100-101, 474 (1998). It will simply be recalled that the working potential (Vₒₙ) is chosen in the electroactivity barrier of the monomer, which starts at around −2,5 V/(Ag⁺/Ag). The relaxation potential (V_{off}) is chosen to be a lower value, in absolute value, than the initial equilibrium potential (−0.6 V/(Ag⁺/Ag) which, via an oxidation reaction involving the solvent, enables the creation of a molecular defect, a cross-linking which stabilises the chains formed on the surface of the electrode. These conditions are the basic conditions used for synthesis of P4VP films, it will be seen later when presenting results that “additives” are incorporated in the solutions to optimise synthesis conditions and film properties.

The conditions for electrochemical synthesis are the following:

| Monomer concentration: | 50% in acetonitrile | |
|---|---|---|
| Pulsed electrolysis: | Vₒₙ = −2.8 V/(Ag⁺/Ag) | tₒₙ = 200 ms |
| | V_{off} = 0 V/(Ag⁺/Ag) | t_{off} = 400 ms |

| | |
|---|---|
| Number of pulses: | 1000 to 4000 (depending upon desired thick- |
| | ness, 50 to 200 nm). |

3. Results

3.1 Laboratory Sample Phases, Surface Area=2 cm²

This first step conducted on laboratory surfaces, vacuum metallized glass strips, is used to identify and optimise film synthesis conditions and operating conditions, complexing/expelling cycles, which simulate the functioning of an industrial process. The inventors used their own spectroscopic means for surface analysis: IRRAS, XPS, Profilometry.

3.1.1. Experimental Conditions

Initial tests on the ability of electrografted P4VP films to fix and release copper salts were made on glass surfaces metallized with nickel using a radiofrequency method.

The synthesis cell used is a small volume glass cell whose compartments are separated by sintered glass. The surface area of the glass strips coated with the films is close to 2 cm² and corresponds to the diameter of the sintered glass.

The working compartment, nickel electrode with cathode polarisation, is packed with a solution containing 5% monomer, 4-vinyl pyridine and 50% acetonitrile. The TEAP concentration is 5×10⁻² mol. dm⁻³.

The counter-electrode compartment, platinum electrode with anode polarisation,is packed with a solution which does not contain any monomer.

The control electrode is based on the system AG⁺/Ag (10⁻² mol. dm ⁻³).

The compartments are separated to limit the oxidation reaction of the monomer which leads to the formation of an insulating film on the surface of the counter-electrodes. These films are mainly formed of insoluble compounds and of P4VP chains that are radically polarised. The lack of swelling properties of these films means that the functioning of the cell is gradually blocked. However, the separation of the compartments with sintered glass is not sufficiently effective with this cell and the slow diffusion of the monomer into the compartment leads to blocking the counter-electrode. The inventors therefore had recourse to regular changing of the counter-electrodes. This problem was minimised during the following steps through the use of better performing separators.

To meet the choice of a method giving priority to the surface aspect of the method, the P4VP films must remain thin. However, it is to be understood that the capacity of a film with an ideal surface whose thickness is only that of a monolayer, less than 1 nm, is too low and would require an infinitely rapid capture/expelling cycle rate in order to acquire minimum efficiency. The films deposited on working electrodes have a thickness of between 50 and 200 nm. Thickness measurements are made by profilometry by making a scratch in the film. The homogeneous nature of these films also makes it rapidly possible to estimate their thickness by means of interferometric colours.

3.1.2. Study of the Complexing Step

a. Detection of the Complex and Copper/Pyridine Stoichiometry

This step made it first of all possible verify the swelling capacity of the films vis-à-vis aqueous solutions. It is necessary that the solution to be depolluted is able to penetrate and diffuse inside the films with a favourable distribution coefficient in respect of the copper.

IRRAS and XPS analyses were able to show that P4VP films immersed in concentrated copper solutions (20 g/l) withheld the copper even after abundant rinsings. The formation of cupro-pyridine complexes is identified by the existence of a band at 1617 cm⁻¹ in IR spectra.

The electronic structure of the copper means that it can be described as a metal complexed in an octahedral structure, that is to say one copper per eight ligands. However, the particular conditions of low mobility of the pyridine ligands related to the solid nature of the polymer considerably and favourably modify this stoichiometry. With the uncertainties connected with the analysis of IRRAS and XPS peak intensities, it is nevertheless possible to estimate that the proportion of copper relative to the pyridine groups is on average 50%, the average stoichiometry for the complexing of the copper atom per two pyridine groups. Some experiments however gave complexing rates close to 100%. To summarise, the complexing rate of copper, that is the number of pyridine groups related to a copper, varies with the copper content within the film, and tends towards 1 per 1 stoichiometry at high contents.

These results are confirmed by IRRAS spectroscopy: the copper/pyridine proportion is estimated by the ratio of the surface areas between the peaks at 1600 and 1617 cm⁻¹ which respectively correspond to the free and complexed form of pyridine. Digital breakdown, using adjustment of the experimental spectrum with a spectrum recomposed from Gauss values centred on the peaks at 1600 and 1617 cm⁻¹, makes it possible to determine the proportion of pyridine groups involved in the complexes. However, with no knowledge of the number of pyridine ligands per copper atom, it does not give the actual quantity of copper in the films.

This information can be provided through the use of XPS spectroscopy which directly determines the actual proportion of the different atoms present on the surface. The intensity of the Cu₂ₚ photoemission bands for copper and of N₁ₛ for nitrogen are used to determine the actual proportion between these two elements. These intensities must however be normalised in terms of cross-section which take into account the yield of photoemission particular to each electronic level of each element. Also, the cross-section is dependent upon the chemical form of the element. The inventors use the cross-section of copper oxide CuO as the approximate form of copper sulphate, for which the extent of copper oxidation is identical. This approximation leads to introducing slight uncertainty. The copper/nitrogen concentration ratio determined in this manner on a thin sample that is highly complexed, IRRAS close to 100%, is close to one unit. This gives the result already demonstrated with XPS.

It is therefore possible to use the ratios obtained by IRRAS to quantify the copper contents.

The observed tallying between the two methods, IRRAS and XPS, for which the spectra were recorded on thin films, that is to say with good surface/volume conformity, means that the IRRAS spectra can be validated and used quantitatively.

Using this measured value, it is possible to estimate the quantity of fixed copper for a given surface area of film. If the density of the film is close to 1, low content, a film surface area of 10 cm² and of thickness 200 nm is necessary to fix 0.1 mg of copper. It is to be noted that these very low values must be multiplied by actual contact surface area and the thickness of the films to have an indication of the quantity of copper ions complexed per cm² of apparent surface area. This point will be examined later.

b. Kinetics of the Complexing Reaction

If, for high concentrations of copper of 20 g/l, the complexing times are short, a few seconds being sufficient for significant film complexing, this is not the case for solutions 1000 times (20 mg/l) or 10 000 times (2 mg/l) more dilute, which may relate to at least part of industrial solutions to be treated.

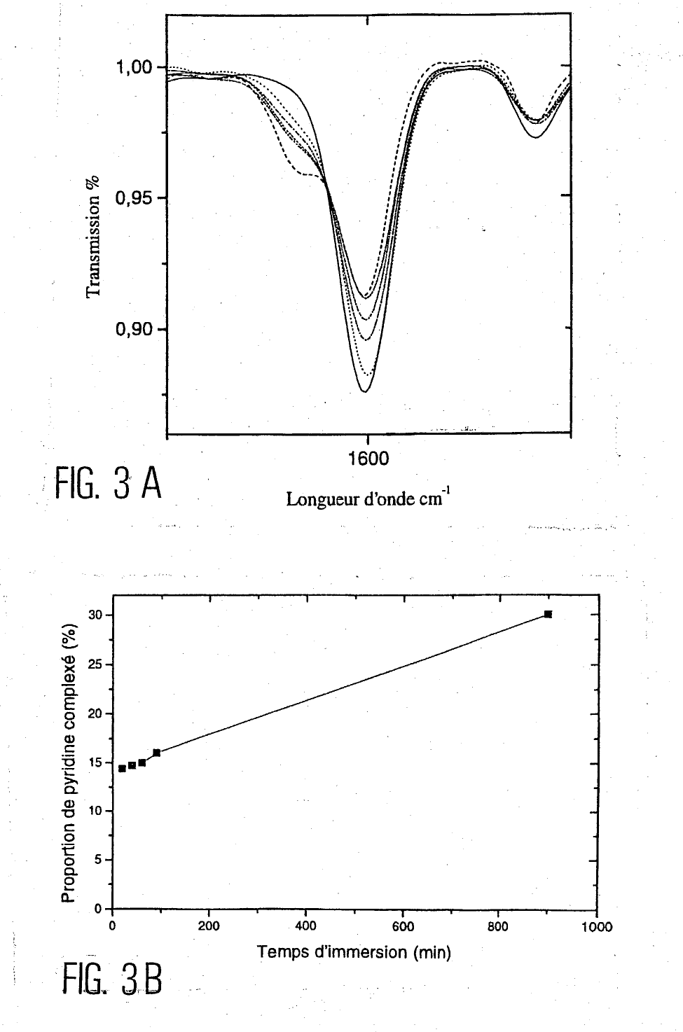

FIG. 3a shows the results recorded at the IR bands of pyridine and its complex with copper for a P4VP film immersed in a 15 mg/l solution. This value is representative of an average content of effluent purified in conventional manner. The calculations of proportions of complexed forms estimated using the areas of IRRAS bands are given in FIG. 3b.

The P4VP film of 100 nm is electropolymerised on a nickelled glass strip. Its surface area is 3 cm². The solution not being shaken, the sample is immersed in a volume of solution that is reduced to a minimum, that is to say 10 cm³. AN IRRAS recording is made at regular time intervals. The onset of the band of the complex at 1617 cm⁻¹ reaches 5 to 10% of the complexing level relatively rapidly, but a time of 15 hours is needed to achieve 20% of the complexing level.

This result can be analysed in several manners set forth below.

One first positive point is related to the fact that despite a very low content in solution, complexing occurs. There is no lower concentration limit below which the complex is no longer formed. This point of view will be furthered below. The complexing constant is such that there is continuous displacement of the copper towards the film irrespective of the concentration in solution. In terms of distribution coefficient of the copper between the solution and the film, the formation of the complex is favourable.

A second positive point is related to the fact that even if the advancement of copper fixation is slow, a time of 14 hours being needed to double the quantity of copper, the content rapidly settles at significant values. Measurement conditions did not make it possible to obtain the copper proportions right from the start. This possibility will be available in the sequence to this study through the introduction of “in situ” electrochemical impedance methods. At this stage in results, it is important to comment upon the values for the “proportion of complexed pyridine”. By intuition it would seem that complexing of the copper starts on the surface of the film, this meaning that this value is dependent upon the thickness of the film. For one same quantity of complexed copper, this proportion will be higher for a thinner film. This value must not therefore be given strict interpretation as an estimation of depositing performance. Thin films may be sufficient to complex very dilute solutions, whereas thicker films may be useful for isolated increases in copper contents.

In this example, many parameters are unfavourable however for the molecular meeting of ions and film. The surface (film)/volume (solution) ratio is very low with a flat strip, and the fact that the solution is not shaken is also unfavourable. The meshes divide the liquid into very fine volumes which means that the flow, which is necessarily non-laminar, is able to set up “shaking”. These results clearly show that between the alternative, in connection with this type of method, of achieving high complexing rates and then to expel, or of accepting a much lower rate but in much quicker time and with much more frequent expelling, the latter solution gives better performance.

The P4VP films grafted by electropolymerisation therefore complex the Cu²⁺ ions, even in thin layers.

This complexing is easily detectable under IRRAS, with the onset of a band at 1617 cm⁻¹, characteristic of the pyridinium group.

Complexing is quantitative, but slow on films grafted on strips and without shaking.

3.1.3. Study of the Expelling Step: Choice of Method

Once the complexing step is completed, the copper ions must be efficiently expelled. At this level of the method, it is important that this step should be conducted rapidly and only generates little secondary waste. Expulsion must therefore be conducted with agents that are only scarcely noxious and/or in volumes as small as possible.

For this purpose, several methods were tested whose aim was to de-complex the copper of the pyridine and to extract it from the film. It is to be noted that the various types of treatment tested made it possible to verify the excellent chemical stability of electrografted films in respect of harsh chemical treatments, unlike the case for control films made by “hardening” polymer solutions which were rapidly removed from the surface.

a. Treatment of Films with Boiling Water

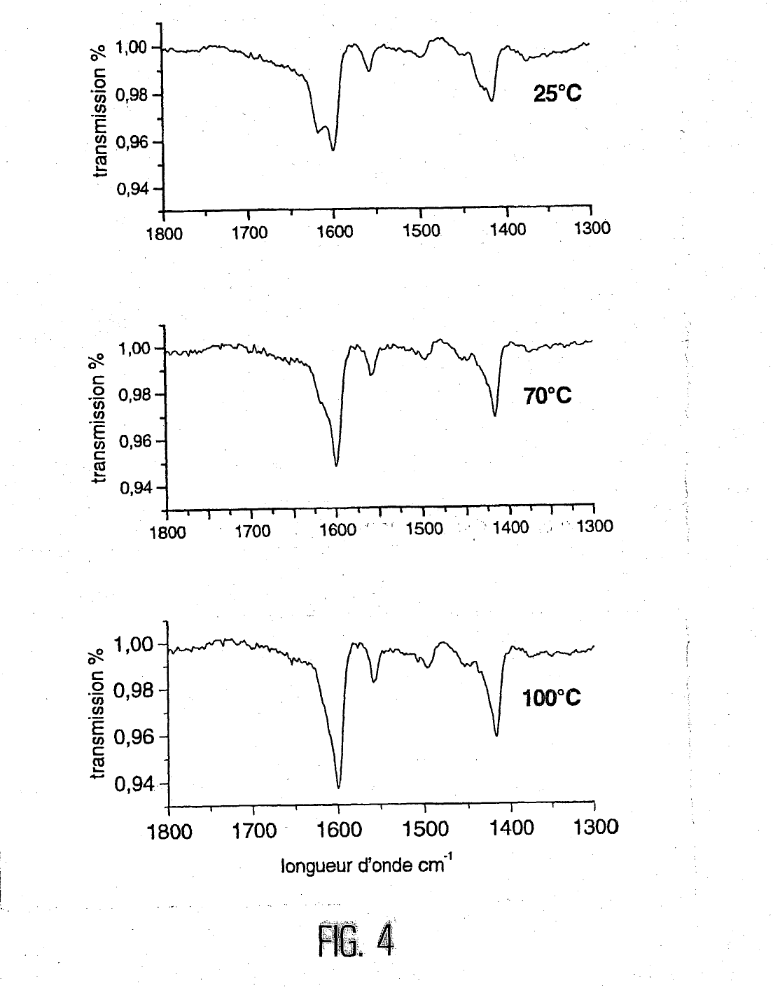

This first test was used for its low noxiousness. It was based on the idea that a supply of heat energy could stabilise the cupro-pyridine complex. With IRRAS analysis, the first rinsing tests in hot water showed a reduction in intensity of the complex band and correlatively regeneration of the free pyridine. These tests were continued using water at 70° C. then with simmering water. A few minutes' treatment cause the complete disappearance of the IRRAS band of the complex of a 100 nm film complexed to 2/3 (FIG. 4).

XPS analysis showed that copper traces persist on the surface of the film whereas the in-depth copper content remains identical after ion abrasion. It is therefore evident that even if the complex is destroyed, the copper is not properly removed from the films. It is probable that hydroxide forms must be formed in the film. Nonetheless, this result is of interest as it at least allows restoration of the reactivity of the pyridine groups. This treatment with boiling water could in the long term be associated with the treatment chosen for limiting the use of more polluting products.

The treatment of complexed films with boiling water therefore brings efficient film decomplexing, but cannot expel the ions from the film.

b. Treatment with Acid/Base Cycles

The pKₐ of pyridine is close to 4.5 and treatments with acetic acid or dilute hydrochloric acid gave the pyridinium form shown by the IRRAS band at 1640 cm⁻¹ in FIG. 5. Nitrogen protonation causes the pyridine group to lose its low basic properties related to its electronic doublet. The copper is then expelled and released in the film and then in solution. This is termed acid washing.

At this stage, the P4VP film having lost its complexing properties, the pyridine form must be regenerated. A basic treatment is needed since a simple move up to a pH medium higher than the pKa does not permit elimination of the pyridinium form. This therefore leads in this case to two treatment steps: acid washing followed by neutralisation. This is not a desirable situation for a method which sets out to generate the least possible secondary waste.

The acid treatment of complexed films therefore provides efficient decomplexing, but requires subsequent re-neutralisation so that the film can be used again for complexing.

c. Direct Basic Treatment, Ammonia Method

This approach directly uses the change to a basic solution. The base chosen was ammonia (NH₃) so as to create a more stable copper complex than the one formed with pyridine and therefore able to move the copper. Ammonia also offers the advantage of being a non-expensive product.

The results presented in the following paragraphs show the efficacy of this treatment and its innocuousness in respect of the films.

Study of the Decomplexing Step Using an Ammonia Solution.

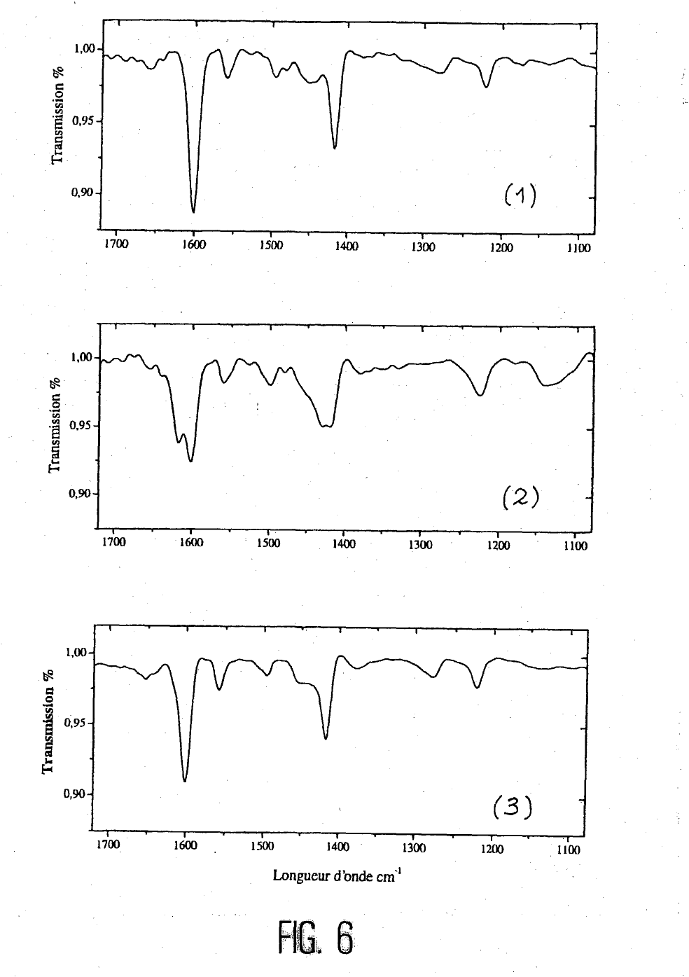

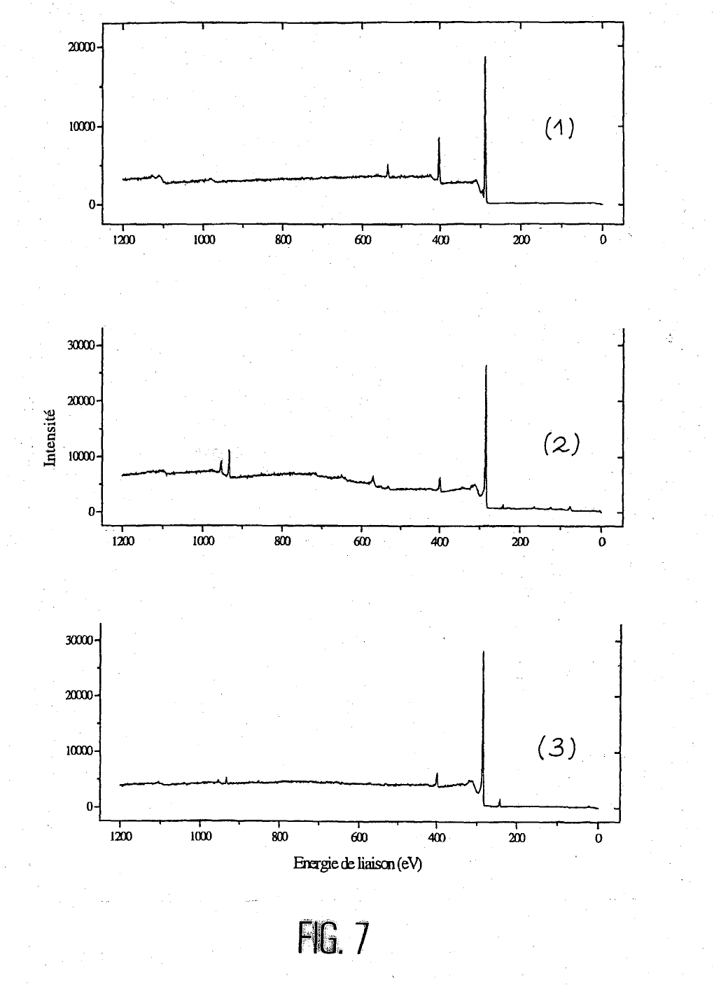

The P4VP films used for this study were synthesized under usual conditions (monomer: 50%, Vₒₙ=−2.8 V/(Ag⁺/Ag), t^{on} =200 ms, V_{off}=0 V/(Ag⁺/Ag), t_{off} =400 ms, n=2000, thickness=100 nm). The IRRAS and XPS spectra of the films in their initial state were recorded and are respectively shown in FIGS. 6 (1) and FIG. 7 (1).

To conduct the complexing step, these films were immersed 5 minutes in a 10 g/l copper solution.

After abundant rinsing with de-ionised water, the IRRAS and XPS spectra were recorded and are respectively shown in FIGS. 6 (2) and 7 (2). Under these conditions, nearly 50% of the pyridine groups were complexed. The weaker apparent intensity of the copper bands in the XPS spectrum relates to the abundant rinsing which washes the film very superficially. However, the IRRAS spectra can be used quantitatively.

The ammonia solution prepared was 1.1 mol.dm⁻³, a dilution in the order of 10% pure ammonium.

The decomplexing step was very rapid, a 1-minute immersion time being sufficient to remove the copper from the film. The films were also rinsed in hot water before analysis. The IRRAS and XPS spectra are respectively shown in FIGS. 6(3) and 7 (3) and evidence the removal of the copper.

As shown by the IRRAS spectrum in FIG. 6(3), the band at 1620 cm⁻¹ corresponding to the pyridine-Cu²⁺ complex has practically disappeared after the decomplexing cycle, with ammonia solution and hot water, and correlatively the pyridine band is seen to re-appear at 1600 cm⁻¹. The low proportion of copper remaining after this treatment is only a few percent. The efficacy of this operation is greater than 90%. The remaining trace of copper can however be totally eliminated to produce complete regeneration of the film if the film is treated with boiling water for 1 hour. This additional operation may be performed occasionally and does not cause any deterioration in film performance.

It is to be noted however, that there is a slight decrease in the IR intensity of the pyridine group after treatment with ammonia with no apparent decrease in film thickness. This phenomenon is interpreted in terms of extraction of polymer chains simply inserted in the film. As shown in the following paragraph, this phenomenon tends to disappear very rapidly over the cycles.

Basic treatment (NH₃) of complexed films therefore provides both good decomplexing and good expelling from the film, and in fast time. Periodic treatment with hot water makes it possible to regenerate almost completely the initial capacities of the film to complex copper ions.

Resistance of Films to Cycling

This example was used to verify that the complexing/expelling cycles of the copper ions do not deteriorate film properties. A stability test was performed by submitting the film to a great number of cycles.

To conduct this test, a highly concentrated ammonia solution, 50% by volume of commercial solution, i.e. ≈8 mol.dm⁻³, was chosen. These harsher conditions in terms of pH allows the film to be tested under limit conditions.

The complexing steps correspond to immersion of the film for one minute in a concentrated CuSO₄ solution. The decomplexing steps were conducted in concentrated ammonia followed by rapid rinsing in boiling water.

IRRAS analyses were made for each step during the first ten cycles, then once every ten cycles up to 150 cycles.

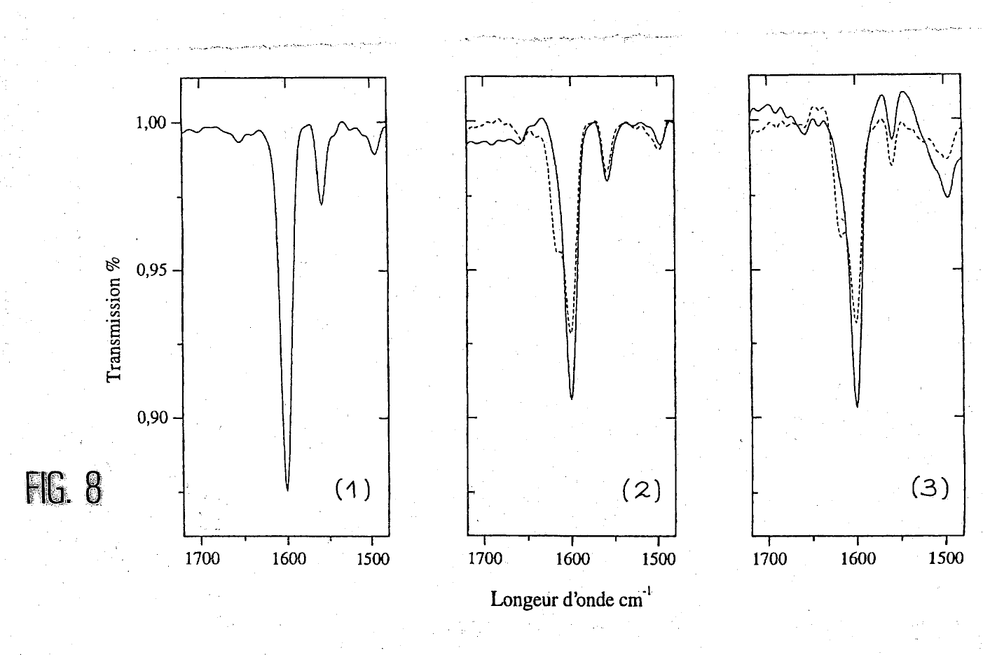

After 150 complexing/expelling cycles, film resistance proved to be excellent and performance showed no deterioration as illustrated in FIG. 8.

As pointed out in the preceding paragraph, the intensity of the pyridine band at 1600 cm⁻¹ decreases substantially between the first and second cycles. This decrease is no longer observed however over the following cycles: the film reaches a stable thickness.

The properties of the grafted film therefore remain non-deteriorated after 150 complexing/decomplexing cycles. They can be put to full use for example through the combination of ammonia treatment with periodic regeneration in hot water.

Study of Residual Copper Contents in the Diluted Effluent (Recyclable)

This example was used to confirmed that the copper is indeed complexed by the film and then expelled in the ammonia solution, and that a repeat of this operation effectively purifies the copper solution.

For this experiment, the inventors used 10 ml of CuSO₄ solution, Cu²⁺concentration 15 mg.l⁻¹, and two strips coated with film having a thickness in the order of 100 nm.

The conditions under which this experiment was conducted were very limitative in respect of reaction speed since the copper content in the solution was low, the exchange surface area was small and no shaking was used to promote contact statistics between the copper ions and the film.

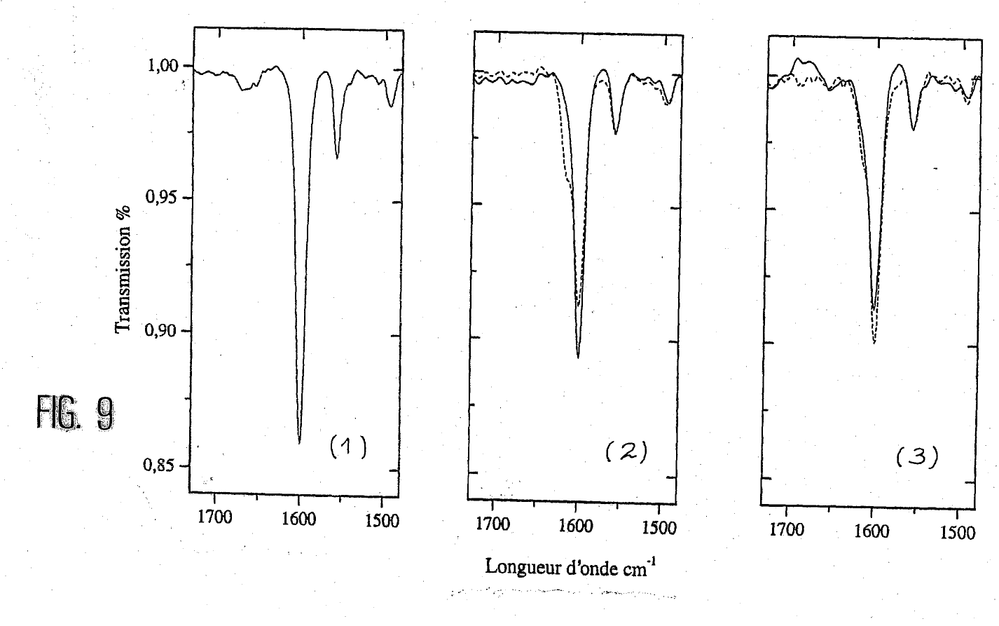

The complexing step is particularly slow under these conditions since an immersion time of 12 hours is needed to complex approximately 15% of the pyridine groups during the first cycle, FIG. 9. The strip was then decomplexed with an ammonia solution and then re-added to the solution to be purified. After the fourth cycle, the IRRAS component of the complex became difficult to observe. In this situation, the copper content was measured using a calorimetric test (visiocolor) with good accuracy at: C_{Cu2+}=0.25 mg.l⁻¹, (European standard 2 mg.l⁻¹).

The initial concentration being 15 mg.l⁻¹, the copper content had decreased by a factor of 60.

Even if this type of experiment remains far removed from a purification sequence on an industrial scale, it does show that there is no limitation of a chemical nature to the approach used. The quantity of copper fixed per unit surface area tallies with the value given previously: 0.1 mg copper per 10 cm² of 200 nm film.

The measurements with the colorimetric test are easy to take and low cost (visiocolor test). The accuracy and reliability of the test were tested on solutions with calibrated concentrations chosen within the measurement range of the method. These solutions of copper sulphate dissolved in de-ionized water were made by precise weighing. The visiocolor measurement range lies between 0.04 and 0.5 mg/l. Dilutions of the solutions to be measured had to be made when necessary to adjust to the contents accessible with the method.

Complexing with a P4VP film grafted onto a strip therefore makes it possible, in 4 pass cycles, to move down from 1.5 mg/l to 0.25 mg/l, i.e. approximately 10 times below the threshold concentrations fixed by French regulations. The gain in concentration is by a factor of 60. Solely the kinetics of the pass cycles remain slow in this strip configuration.

Study of Copper Contents in the Concentrated Effluent. Determination of the Concentration Factor of the Waste.

To achieve substantial efficacy of the developed method, it is important firstly to lower the content in the recyclable effluent as much as possible, but above all to concentrate the heavy ion in the smallest volume of purification bath. The ratio between initial volume to be treated and end volume of concentrated solution expresses the performance of the method.

Therefore, a decomplexing experiment was conducted with different ammonia solutions, C≈1.6 mol.1⁻¹ containing the formal complex Cu(NH₃)ₙ²⁺SO₄²⁻ where n=1,2,4,6, 8, 10, 20, 40, 60, 80, 120, 160.

This experiment made it possible to determine the maximum quantity of copper which may be contained in the ammonia solution in saturated solution, while continuing to maintain its efficiency as regards decomplexing.

The dissociation constants of the complex help give an idea:

Cu[NH₃]₆²⁺ [symbol] Cu[NH₃]₅²⁺+NH₃

where

K_{D6}=[Cu(NH₃)₅ ²⁺]. [NH₃]/[CU(NH₃)₆²⁺]

Cu[NH₃]₅²⁺ [symbol] Cu[NH₃]₄²⁺+NH₃

where

K_{D5}=[Cu(NH₃)₄²⁺]. [NH₃]/[Cu(NH₃)₅²⁺]

Cu[NH₃]²⁺ [symbol] Cu²⁺+NH₃

where

K_{D1}=[Cu²⁺]. [NH₃]/[Cu(NH₃)²⁺]

in which pK_{D1}=4, pK_{D2}=3.3; pK_{D3}=2.7; pK_{D4}=2; pK_{D5}=−0.5; pK_{D6}=−2.5.

Also, the strength of a complex is defined by the equilibrium constant K. For example, for the complex Cu[NH₃]6²⁺with the equation:

Cu[NH₃]₆²⁺ [symbol] Cu²⁺+6 NH₃

The global equilibrium constant K₆ is written:

K₆=[Cu²⁺]. [NH₃]⁶/[Cu(NH₃)₆²⁺]

therefore

pK₆=pK_{D1}+pK_{D2}+pK_{D3}+pK_{D4}+pK_{D5}+pK_{D6}i.e.pK₆=9.

Therefore, for each Cu(NH₃)ₙ²⁺complex, there is access to the global equilibrium constant Kₙ:

pK₁=4; pK₂=7.3; pK₃=10; pK₄=12; pK₅=11.5; pK₆ 9.

Consequently the higher pK, the more stable the complex. On the basis of the constant values, it can already be deduced that the maximum limit, corresponding to the end of copper complexing by ammonia with high efficiency, will be reached at complex n=4.

Using these constant values, it can already be deduced that the maximum limit, end of copper complexing by ammonia with high efficiency will be reached at complex n=6.

The experiment conducted on P4VP film complexed and then decomplexed in an ammonia solution, of n=160 to n=1, clearly shows saturation and total loss of efficacy when the copper content has reached threshold n=10, i.e. Cu[NH₃]₁₀²⁺. At this stage, an equilibrium occurs between the forces tending to complex the copper in the concentrated effluent and those tending to re-form the complex in the film under the action of high concentrations of concentrated effluent.

The calculation of the quantity of copper which can be incorporated in the concentrated effluent is simple. From one litre of ammonia solution with a concentration of 1.6 mol.l⁻¹, it will be possible to “recover” a maximum of 0.16 mole per litre of Cu²⁺, that is to say 10.1 g of copper per litre.

If, initially, the solution to be depolluted contains 15 m.l⁻¹, it will be possible to de-complex 14.7 mg of Cu²⁺ per litre.

In this case, 10.1 1/14.7×10⁻³≈700 litres of solution to be depolluted will then be needed to saturate 1 litre of ammonia at 1.6 mol.l⁻¹, i.e. a reduced volume factor of 700.

Therefore, by increasing the ammonia concentration, the volume reduction factor will be increased. These results are set forth in table B below. Resistance tests to cycling were made in a solution of 1.6 mol.l⁻¹, however tests in more concentrated solutions did not evidence any particular difficulties. If it is possible to concentrate 10 g of copper per litre or more, it will then be possible to finally treat this litre of concentrated effluent by conventional precipitation methods with hydroxides using cement lime, quick lime for example, and to form a dry residue.

TABLE B
Concentration level of the method in relation to the
concentration of expulsion solution (NH₃)

| NH_{3 concentration} | | | | |
|---|---|---|---|---|
| (mol .1⁻¹) | 1.1 | 1.6 | 3 | 16 |

| | | | | |
|---|---|---|---|---|
| Concentration level | 500 | 700 | 1300 | 7000 |
| or quantity of copper | | | | |
| solution (15 mg.1⁻¹) | | | | |
| in L | | | | |

The volume gain between the incoming solution and the discharged solution therefore depends upon the concentration of the ammonia solution and therefore on the price of the extraction solution. Depending upon this concentration, the gain factor may reach 7000, that is to say 1 litre of discharge solution per 7 m³ of treated solution.

3.2 Phase on Flat Strips or Wire Mesh of Average Size (10 cm²)

This part concerns the consideration given to filter preparation conditions and filter use in industrial environments.

3.2.1 Design of a Teflon Cell with Membrane Separator

The synthesis mode for P4VP films by electropolymerisation is re-described below for its adaptation to the production of mesh used to form the complexing structure of the present invention.

The formation of an insulating layer of P4VP on the counter-electrodes was described above. The difficulties have been minimised, firstly by changing the counter-electrodes whenever necessary, and secondly by designing a glass cell with sintered glass separation between the two compartments to limit the diffusion of the monomer. At the start of the experiment, there is 50% monomer in the cathode compartment and 0% in the anode compartment.

In respect of the counter-electrodes, strips of metallized metal are preserved by sputtering. With this approach, it is possible to have numerous counter-electrodes which may. be arranged regularly. Solid platinum electrodes would be too costly.

The use of sintered glass, which can be considered for the design of a glass cell, is less possible for larger-size cells which can be used in an industrial environment. This is why the inventors chose a new type of separator, since it is essential to minimise monomer reactions on the counter-electrode. These separators must slow down the diffusion of species from one compartment to the other without blocking the flow of current.

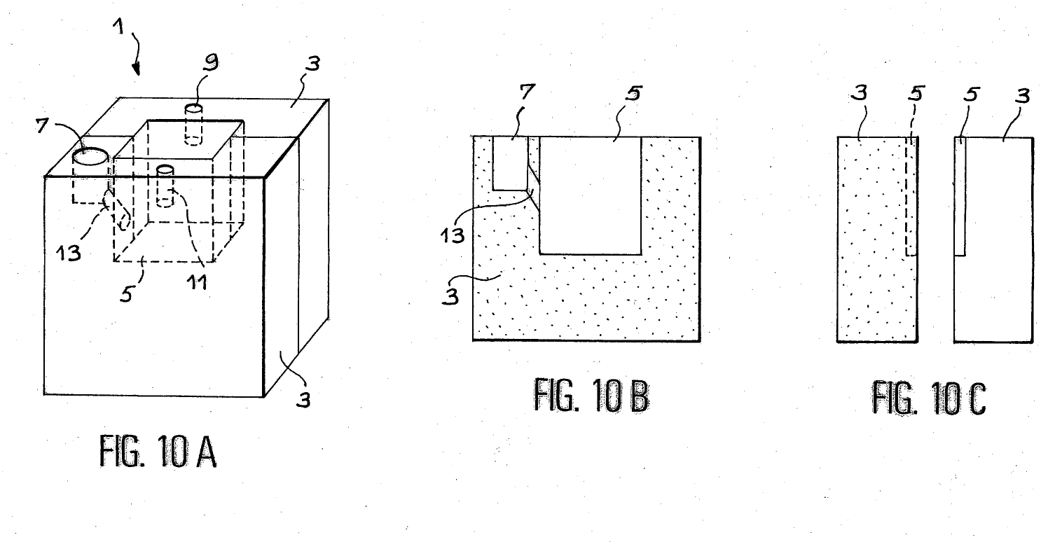

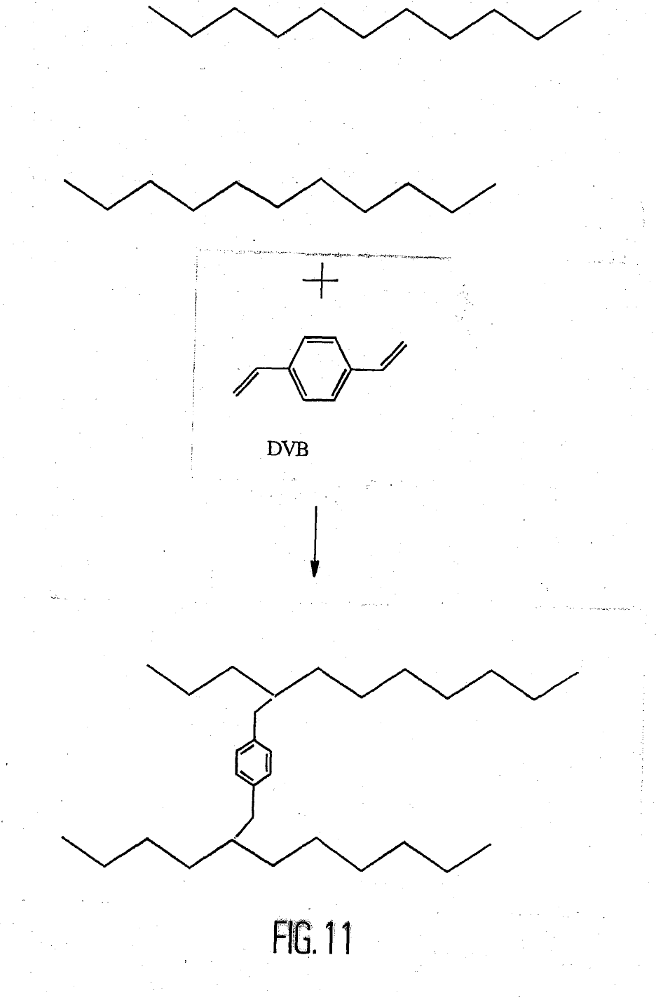

The choice of separator being related to the type of cell material, Teflon was chosen to make this new cell. The cell designed in two Teflon blocks is shown in FIGS. 10A, 10B and 10C.

In these figures, reference 1 denotes the cell, reference 3 denotes a block separately, reference 5 denotes the filling area of the synthesis mixture, reference 7 denotes the housing of the control electrode, references 9 and 11 denote the anchor points which, via a bridge (not shown) are used to secure the assembly, and reference 13 denotes the communication duct between the housing of the control electrode and the synthesis area.

It can be easily dismounted and allows the use of a membrane separator. The flexibility of Teflon makes it possible to properly secure the membrane and to achieve good cell sealing.

The first membranes chosen were of TRMC metallo-ceramic type with a pore diameter of 0.07 micrometres. The composition of the membrane is as follows: 316 L stainless steel/ZrO₂/TiO₂.

The porous ceramic elements are arranged in thin layers on a stainless steel matrix. Although electrically insulated from the two electrodes of the cell, the electric field which crosses through the solution generates a phenomenon of secondary polarisation on the conductor part of the membrane. The membrane then operates as a double electrode with anode polarisation in the cathode compartment and conversely in the other compartment. The inventors observed that a film was deposited on the conductor surface of the membrane with the risk of fouling the same in the course of time. Consequently, the use of this type of membrane was set aside in this example.

The second membranes used are fully polymeric. Even though mechanically more fragile, they can be used under our conditions. They are formed of a coating of porous fluorine type (poly 1,2-difluoroethylene) deposited on a polypropylene carrier. The pore diameter was reduced to 0.025 micrometres.

The use of membranes slows down monomer diffusion but does not block it entirely. Therefore, the problems of fouling the counter-electrode persist even if they are largely attenuated.

3.2.2. Studies to Increase the Thickness of P4VP Films

a. Cross-linking with Divinylbenzene

The approach described in this paragraph meets the need to obtain thicker P4VP films. The film thicknesses typically obtained are asymptomatically observed at around 100 to 150 nm beyond 2000 pulses. For situations in which copper contents may be higher, film thickness as an expression of capture capacity may become a parameter of importance.

Some polymer chains are removed during the first ammonia washing. This is due to the fact that not all the polymer chains are grafted onto the surface. A high proportion is simply retained in the grafted part by weak interactions or through interleaving by interdiffusion. One last part is simply released in the solution and contributes to gradual gelling of the electrolyte.

The approach used consists of retaining this last part in the growing film through the addition of difunctional polymerisable molecules in the electrolyte. The divinyl benzene molecule (DVB) may for example allow cross-linking between the chains that are initially insulated and consequently the withholding of a higher proportion of chains.

Tests were conducted using between 1 and 10% DVB added to the cathode compartment. The thicknesses grow up to a content of 5% and then stabilize. The maximum values obtained are close to 5000.

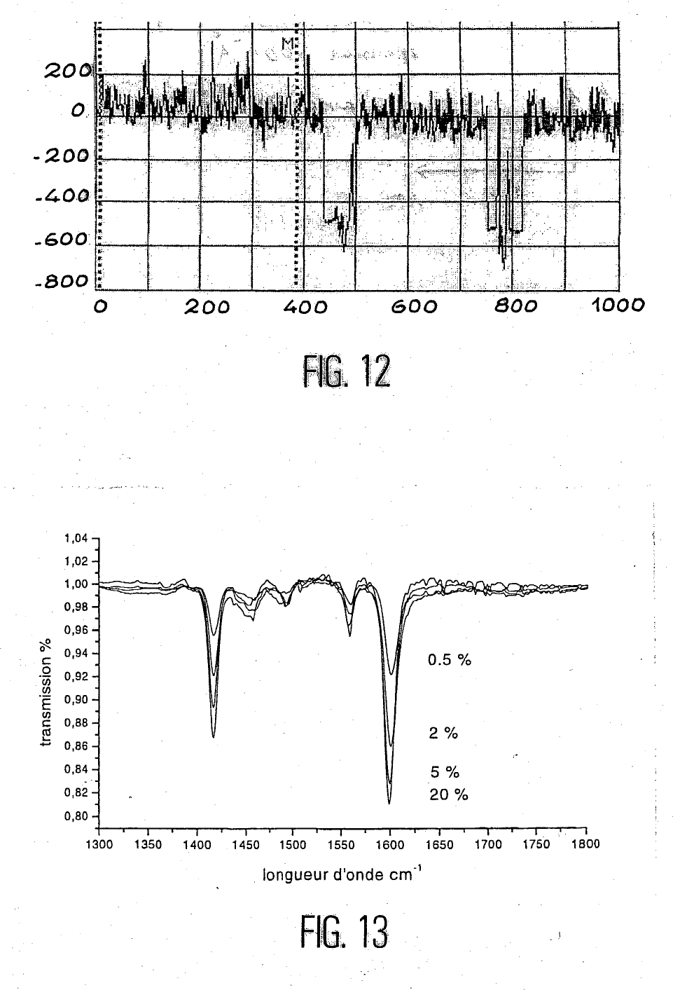

It was therefore possible to multiply film thickness by 5. The results can be seen in FIG. 12.

FIG. 13 shows the IRRAS spectra recorded on these films. It is to be noted that the IR intensities under our conditions of analysis with grazing reflection are not linear with film thickness.

It is fundamental to note that all these films always fix the copper correctly. The DVB did not modify their capacity of being swollen by aqueous solutions.

The use of cross-linking agents, such as divinyl benzene (DVB), therefore makes it possible to increase the thickness of grafted films by a factor of 5. The complexing capacity of the cross-linked film is preserved. On these cross-linked films, the losses in thickness initially seen with non-crosslinked films were no longer observed.

b. Incorporation of Preformed Oligomers

The idea of using preformed oligomers to contribute towards increasing film thickness is derived from observations made during synthesis series. It was observed, when several films are produced successively (without DVB), that the viscosity of the synthesis solution increased, generally accompanied by a brown-red colouring. This observation is related to the formation of oligomer chains in solution which are not retained by the grafted films and which accumulate in time. In parallel, it was observed that film thickness tends to grow from one film to another when the same solution is used for successive syntheses. The oligomers in solution participate positively in film thickening.

The inventors also used solutions which had naturally polymerised during their glove-box storage. Indeed, the monomer distillation operation removes all or part of the stabiliser, that is to say the polymerisation inhibitor.

This test proved positive: the preparation of a synthesis solution with preformed oligomers led to a significant increase in film thickness. A factor of two or three on average was observed in terms of thickness. Values determined by profilometry from 400 to 500 nm were regularly observed. These results are given in FIG. 14.

3.2.3. Synthesis on Wire Mesh

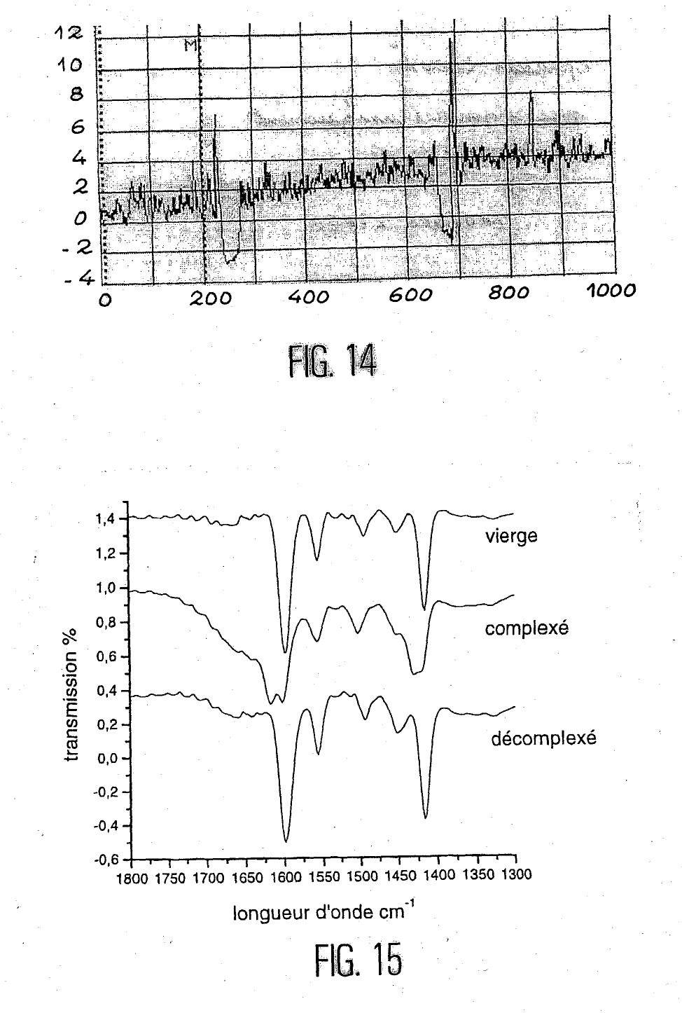

The use of the Teflon cell made it possible to start tests on stainless steel wire mesh. The changeover from radiofrequency nickelled surfaces, on which most optimisations of synthesis conditions were performed, to stainless steel mesh did not apparently give rise to any problems as illustrated in FIG. 15. The presence of chromium oxides does not appear to have reduced film stability.

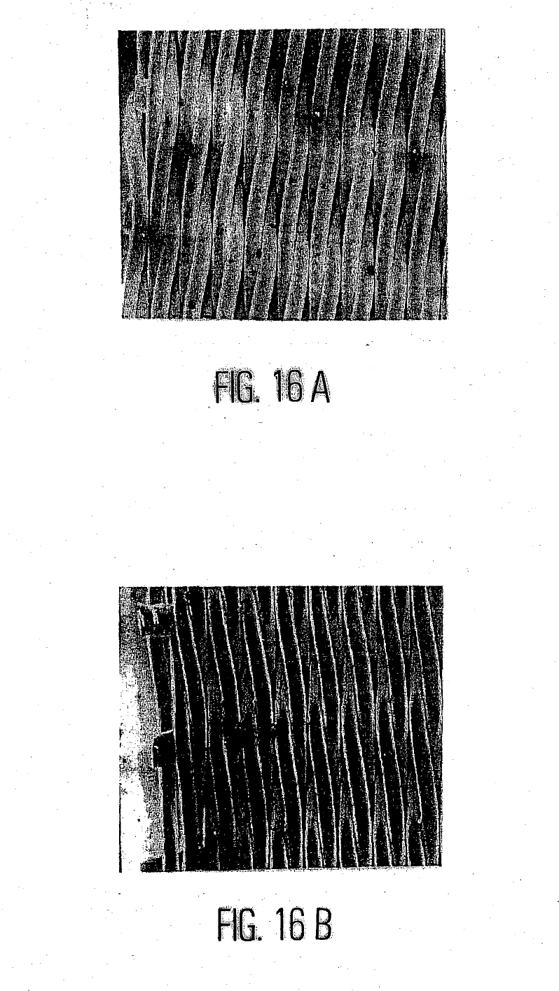

It was even possible to submit the coated meshes to ultrasound for much longer time periods in order to verify their adhesion. 15 mn tests under ultrasound in solvents of the polymer did not modify or visually deteriorate the films. Optic observations under the binocular microscope or electronic scanning microscope (FIG. 16) show perfectly homogeneous deposits on all the wires. This well confirms that the coating method by electropolymerisation is fully suited to these complex geometries.

The changeover to these developed surfaces is fully in line with the aim to reduce the time length of the complexing step. If, from a strictly geometrical viewpoint, and by extrapolating results obtained on flat strips, a mesh 10 cm in diameter can purify 1 litre of 10 mg/l solution, it is evident that such performance cannot be easily achieved by kinetics.

Passes through numerous meshes can then be used to obtain a considerable increase in the exchange surface area between the liquid and the surface of the films.

4) Continuous Treatment Device for Effluent to be Treated

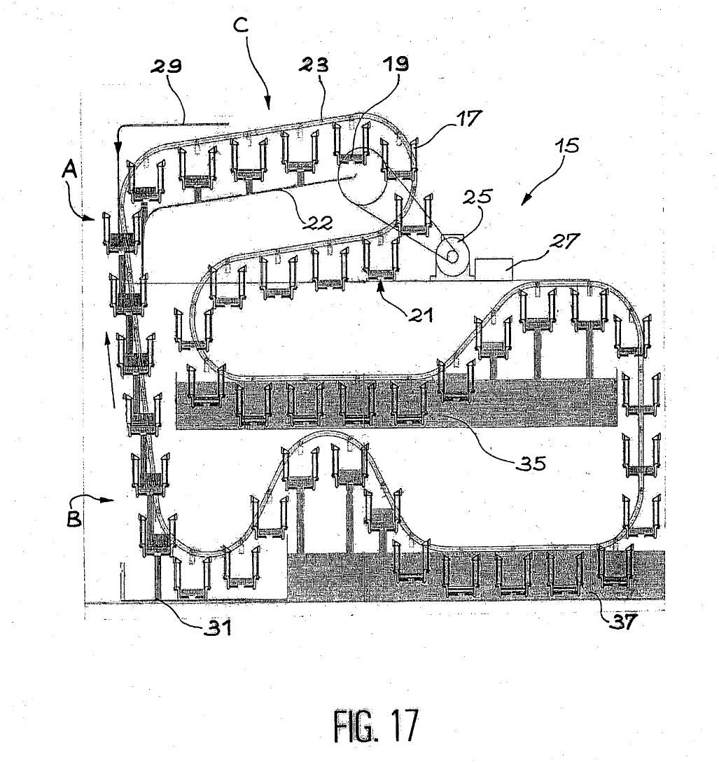

This embodiment is schematised in FIGS. 17, 18 and 19. In these figures, the same references denote the same items. In FIG. 17, device 15 comprises a series of buckets 17 in which meshes 19 are placed forming the complexing structure of the invention. A hole 21 is pierced in the bottom of the buckets.

The device also comprises a driving rail 23 for the buckets 17 to form a waterwheel system and a driving motor 25 for the rail equipped with a variator 27. A supply duct 29 supplies the device with effluent to be treated at point A of the waterwheel system. The treated effluent is evacuated from the buckets at points A, B and C of the waterwheel system and from the device at point B. The treated effluent 31 leaves the device at the bottom left in the diagram. A collection trough 22 for the effluent leaving the bottom of the buckets is provided at point C of the waterwheel system. The system also comprises a first emptying/decomplexing bath 35 and a second emptying/decomplexing bath 37.

FIG. 18 is a perspective diagram of a bucket 17 of the device shown in FIG. 17, on its driving rail 23. A hole 21 is pierced in the bottom of the bucket.

It is pivot mounted in its upper part around an axis 23a on the driving rail 23 so that it can move with the latter in its position “hole 21 facing downwards” along the entire waterwheel system.

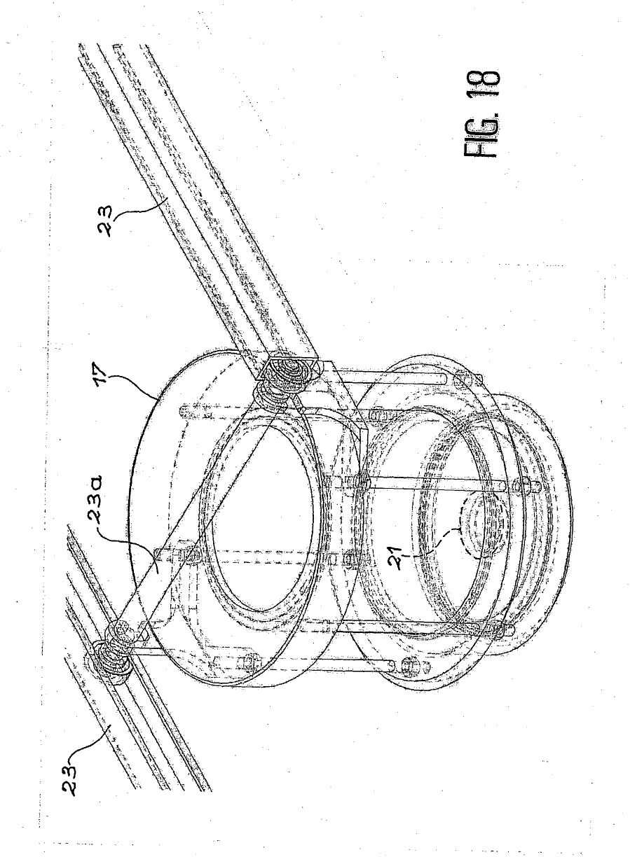

FIG. 19 is a section view of a bucket 17. This diagram shows the positioning of the complexing structure 40 of the present invention. This structure is in mesh form 42. Each bucket may for example contain 10 to 15 meshes. In this diagram the bucket holds 10.

The bucket built for this embodiment comprises an upper crown 44, a tube 46, a lower crown 48, a bottom 50 provided with a hole 21, nuts 52, an O-ring 54, and an O-ring 56. The effluent is able to flow out through the hole after passing through meshes 40.

In FIG. 17 the system is shown so that the waterwheel system circulates continuously in clockwise direction. It rotates in reverse direction to the direction of flow of the effluent entering via A and then immerses in two emptying/decomplexing baths.

Therefore, the effluent to be treated enters the device via A at the top left of the waterwheel diagram, through the top part of the bucket located under the supply duct. The effluent passes through the complexing structure of the invention contained in the bucket and leaves the bucket via hole 21. The trough 22 is intended to collect the treated effluent which continues to flow from the buckets at the top part C of the system. The buckets are then driven towards the first 35 and second 37 emptying/decomplexing baths which regenerate the meshes in the buckets forming the complexing structure of the invention.

5) Example of Application Using the Embodiment of the Device of the Invention Described in Previous Example 4

The bucket made for this example uses an assembly of 7 meshes for cross filtration made in 316L stainless steel and forming the substrate of the complexing structure of the invention, modified by a coating of poly-4-vinyl pyridine which forms the electrically neutral organic polymer film able to complex ions. The total actual surface areas of this complexing structure are therefore high, in the order of 5200 cm³ (or 0.51 m²). They provide for an enormous gain in efficacy: in time and limit concentration.

The inventors passed a solution of 250 ml of effluent to be treated having a concentration of 15 mg Cu²⁺/l through the meshes of the bucket, and they determined the Cu²⁺ ion concentration of the solution in relation to the number of passes in a bucket.

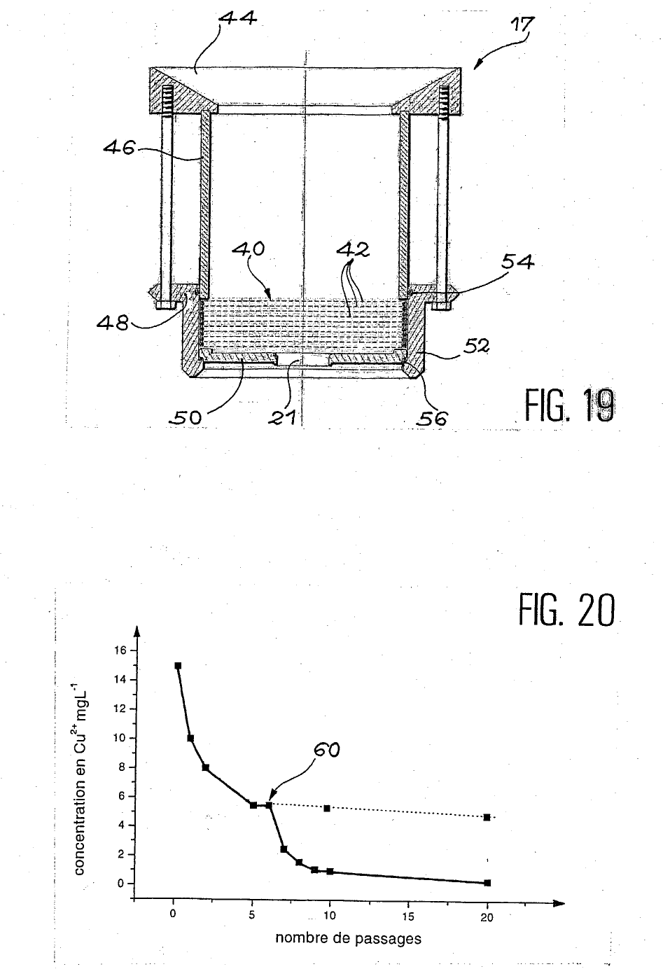

The results of this test made it possible to plot the graph shown in FIG. 20.

This figure shows the changes in copper concentration of the effluent in relation to the number of passes in the bucket with an effluent volume of 250 ml.

In this figure, reference 60 denotes decomplexing. At the sixth pass, the inventors decomplexed the meshes with ammonia, then re-used the same bucket after rinsing in clean water to remove the ammonia. They observed that the complexing capacities of the bucket had been restored, which made it possible to reach very low residual concentrations in the treated effluent after a low number of passes: in the order of 0.5 mg Cu²⁺/l after 20 passes and a single decomplexing operation at the sixth pass. It is recalled that the copper threshold fixed by French regulations is 2 mg/l.

The aspect of the curve shows that it is most probably possible to obtain an identical or better result by using a greater number of decomplexing operations, for example a second decomplexing at around the twelfth pass.

These results show that with the present invention it is advantageously possible to replace the long, quantitative complexing of the prior art by a series of fast complexings/decomplexings.

6) Example of the Use of a Complexing Cavity of Redox Lock Type

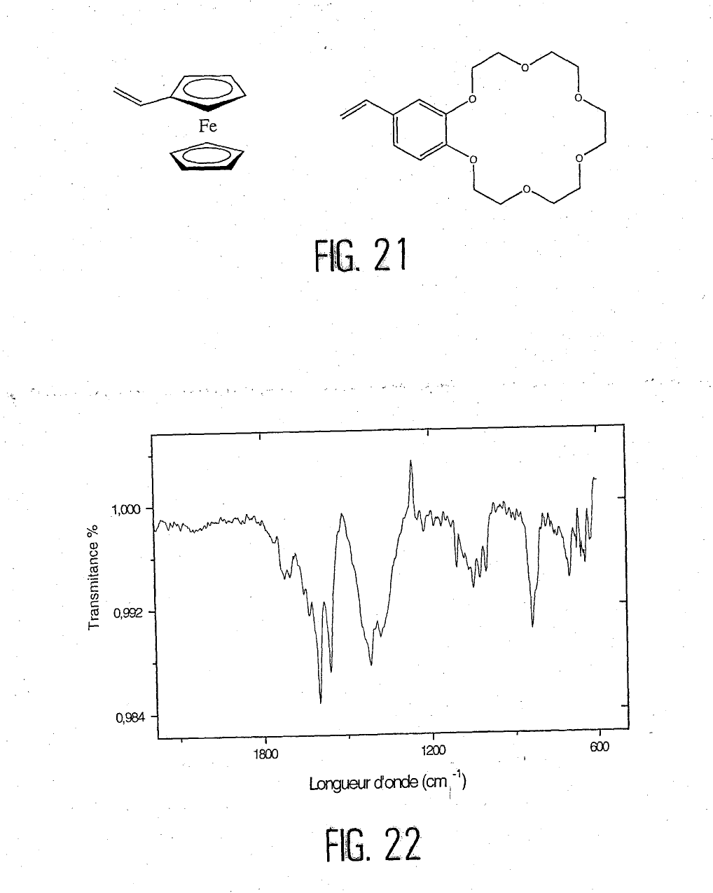

In this applied example, electropolymerisation of vinyl ferrocene alone is conducted by cathode polarisation. The vinyl ferrocene is schematised in FIG. 21. With this experiment it was possible to verify that the mimed redox lock formed by the ferrocene group is chemically stable vis-à-vis cathode electropolymerisation and that it can still be electrochemically piloted when in the polymer film which has been grafted.

Conditions of electrochemical synthesis:

On platinum strip

Control: silver electrode

Solvent: acetonitrile

Electrolyte carrier: TEAP 5.10⁻² mol.L⁻¹,

Monomer concentration: 1 g in 20 ml acetonitrile, i.e. 0.27 mol.L-1,

Pulsed electrolysis, with following protocol:

| | |
|---|---|
| Vₒₙ = −2.7 V/(Ag⁺/Ag) | tₒₙ = 200 ms |
| V_{off} = 0 V/(Ag⁺/Ag) | t_{off} = 400 ms |

Number of pulses: 2000

The film obtained has a thickness of approximately 20 nm, and has the IR structures characteristic of the ferrocene group.

FIG. 22 appended shows the IRRAS spectrum, transmission in relation to wavelength, of the poly-(vinyl)-ferrocene) film obtained by grafting using electropolymerisation under cathode polarisation. The response of the poly-(vinyl-ferrocene) film is measured in a solution of acetonitrile and TEAP.

FIG. 23 shows the voltammetric response of 20 nm poly-(vinyl-ferrocene) grafted onto platinum by electropolymerisation under cathode polarisation. The measurement is made in a TEAP solution 5.10⁻² mol.L-1 in acetonitrile, v=100 mV.s⁻¹. The anodic and cathodic peaks are observed, characteristic of the redox pair that is always reversible associated with the ferrocene group.

7) Example of the Use of a Complexing Cavity of Redox Lock Type

In this example, vinly ferrocene was copolymerised with 4-vinyl benzo 18-crown-6. This experiment showed that the redox lock is co-polymerisable with monomers functionalised by complexing cavities and responds electrochemically in such co-polymerised film.

Conditions of electrochemical synthesis:

On platinum strip

Monomer concentrations: 0.5 g vinyl-ferrocene and 0.75 g 4-vinyl benzo 18-crown-6 in 20 ml acetonitirile, i.e. 0.24 mol.L⁻¹ of monomer,

Pulsed electrolysis with following protocol:

| | |
|---|---|
| Vₒₙ = −2.7 V/(Ag⁺/Ag) | tₒₙ = 200 ms |
| V_{off} = 0 V/(Ag⁺/Ag) | t_{off} = 400 ms |

Number of pulses: 2000

The sample is rinsed in acetonitrile under ultrasound before characterisation. The film obtained has a thickness of approximately 40 nm. Its molecular structure reveals groups characteristic of ferrocene and the crown ether.

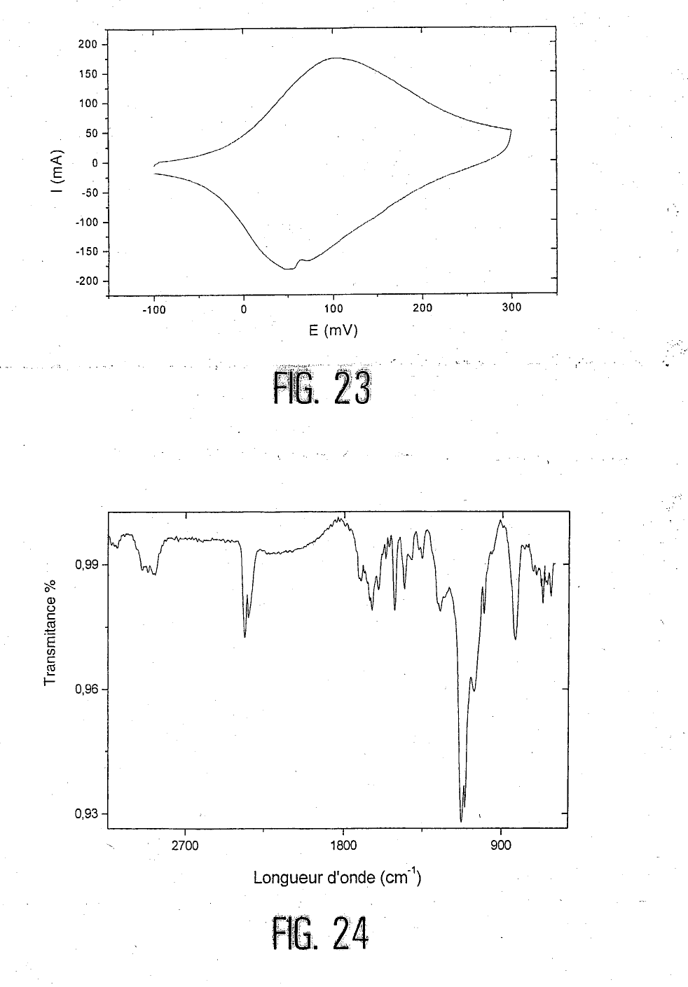

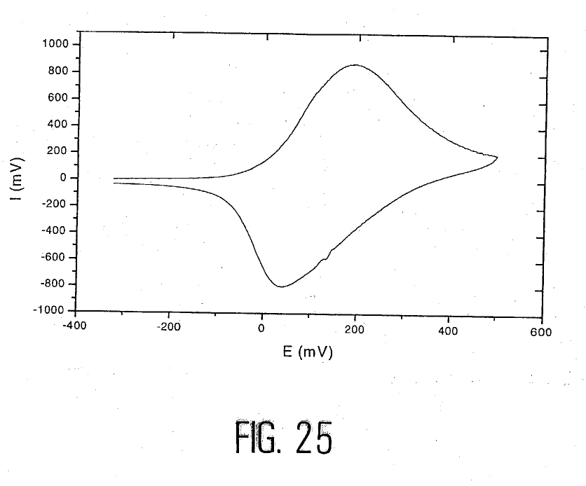

FIG. 24 appended shows an IRRAS spectrum of the film of the invention obtained with a copolymer of vinyl-ferrocene and 4-vinyl benzo 18-crown-6.

### Example 8

A complexing cartridge was made using a tube in polyethylene, opened at one end, and comprising a flow adjustment tap at the other end. This tube was filled with meshes in stainless steel, on which a poly-4-vinyl pyridine film was grafted. These meshes were placed in the tube perpendicular to the direction of the tube. It was then possible to cause the effluent to be treated to flow inside the filled tube, to adjust the flow with the tap and to collect water to be treated in the filled tube, adjust the flow with the tap, and collect treated water at the bottom of the tube as illustrated in FIG. 20. After n passes, n depending upon the concentration of the incoming effluent, the meshes are regenerated: (i) either by passing an ammonia solution through the tube; (ii) or by immersing the complete tube in an ammonia solution ; (iii) or by regenerating the meshes using electro-assistance. The results obtained are equivalent to those of the preceding examples.

### Example 9

A complexing cartridge was made using a polyethylene tube opened at one end, and comprising a flow adjustment tap at the other end. Beforehand, poly-4-vinyll pyridine was grafted onto stainless steel beads 1 mm in diameter. This grafting was obtained by filling a Teflon-meshed tube (registered trade mark) with the beads, the tube being sealed at the two ends by a conductor mesh compressing the beads. The assembly was immersed in the synthesis solution containing 4-vinyl pyridine and grafting took place as described in the preceding examples. The polyethylene tube was then filled with the beads. It was then possible to pass the effluent to be treated through the filled tube, to adjust the flow rate with the tap, and to collect treated water at the bottom of the tube. After n passes, n depending upon the concentration of the incoming effluent, the beads are regenerated: (i) either by passing an ammonia solution through the tube; (ii) or by immersing an electrode in the tube for electro-assisted discharge. The results obtained were equivalent to those of the preceding examples.

1. Complexing structure comprising a substrate on which a film is grafted of a polymer or an electrically neutral organic copolymer able to complex ions.

2. Structure according to claim 1, in which the electrically neutral organic polymer grafted on the substrate comprises:
one or more identical or different functional groups having complexing properties chosen from among amines, amides, ethers, carbonyls, phosphines, phosphine oxides, thio-ethers, disulfides, ureas, crown ethers, aza crowns, thio crowns, cryptands, sepulcrands, podands, porphyrines, calixarenes, pyridines, bi-pyridines, terpyridines, quinoleines, compounds of orthophenantroline, naphtols, iso-naphtols, thioureas, siderophores, antibiotics, ethylene glycol, cyclodextrins, and molecular structures substituted and/or functionalised from these functional groups, and/or
one or more complexing cavities of redox lock type.

3. Structure according to claim 1, in which the polymer is a polymer containing a monomer chosen from among 4-vinyl pyridine, vinyl bipyridine, thiophene.

4. Structure according to claim 1, in which the polymer or organic copolymer film is a copolymer of methyl methacrylate and of methyl methacrylate in which the methyl group of the ester has been replaced by a crown ether provided with a redox lock.

5. Structure according to claim 1, in which the polymer or organic copolymer film is a copolymer of 4-vinyl pyridine and vinyl ferrocene or vinyl diferrocene.

6. Structure according to claim 1, in which the organic polymer film has a thickness of approximately 10 μm or less.

7. Structure according to claim 1, in which the substrate is chosen from among a plate, a strip, a tape, a gauze, a mesh, a wire, a bead, a powder, a chipping and a tube.

8. Structure according to claims 1 and 7, in which the substrate is formed in whole or in part of an electric conductor or semi-conductor material.

9. Structure according to claim 1 or 8, in which the substrate is in 316L stainless steel.

10. Method for treating a liquid effluent to extract ions from the effluent, said method comprising a step to contact the effluent to be treated with a structure according to any of claims 1 to 9 so that the ions to be extracted are complexed by said electrically neutral organic polymer film.

11. Method according to claim 10, also comprising a step to expel the ions complexed by the polymer, said expulsion being conducted by chemical or electro-assisted means.

12. Method according to claim 11, in which the expulsion of the complexed ions being made by chemical means, it is conducted by immersing the film of organic polymer in a solution containing a ligand having strong affinity for the ions complexed by the film.

13. Method according to claim 11, in which the film being a poly-4-vinyl pyridine film, the ions to be extracted from the effluent being copper and/or zinc ions, the expelling of the latter from the film is made with a method using hot water, with a method using ammonia solutions, or with a combination of these two methods.

14. Method according to claim 11, in which the substrate being a conductor or semi-conductor substrate, the organic polymer grafted on the substrate containing one or more complexing cavities provided with redox locks, the expulsion of the complexed ions is made by electro-assisted means by electrically polarising the conductor or semi-conductor substrate carrying the polymer film.

15. Method according to claim 10, also comprising a substrate peeling step to remove the polymer film which complexed the ions, optionally followed by a depositing step to deposit a new polymer film on the substrate.

16. Continuous treatment device for an effluent to be treated comprising:
a complexing structure according to any of claims 1 to 9,
a first container intended to hold the effluent to be treated containing the ions to be extracted,
a second container intended to hold a solution to expel the ions complexed by the polymer of said structure, and
means for causing said structure to be continuously passed, at a controlled rate, successively in the first container holding the effluent to be treated and then in the second container holding the solution to expel the ions complexed by the polymer of the complexing structure.

17. Device according to claim 16, in which the structure is a tape with joined ends.

18. Device according to claim 16, in which the complexing structure is an assembly of meshes arranged in buckets, said buckets being driven by a waterwheel system.

19. Device according to claim 16, also comprising control means with which to adjust the speed at which the structure passes through the first container then through the second container in relation to a flow rate of the effluent to be treated and/or to a concentration of ions in the effluent to be treated and/or in relation to the complexing and decomplexing speed of the ions by the organic film.

20. Continuous treatment device for effluent to be treated comprising:
a complexing structure according to any of claims 1 to 9,
a first container intended to hold the effluent to be treated containing the ions to be extracted, and
means for causing the effluent to be treated to pass continuously, at controlled speed and from the first container, over the surface of or through said complexing structure containing the effluent to be treated.
